(19) United States
(12) Patent Application Publication
(10) Pub. No.: US 2012/0120088 A1
(43) Pub. Date: May 17, 2012

(54) STORAGE MEDIUM HAVING STORED THEREON DISPLAY CONTROL PROGRAM, DISPLAY CONTROL APPARATUS, DISPLAY CONTROL SYSTEM, AND DISPLAY CONTROL METHOD

(75) Inventor: Shinji KITAHARA, Kyoto (JP)

(73) Assignee: NINTENDO CO., LTD., Kyoto (JP)

(21) Appl. No.: 13/185,581

(22) Filed: Jul. 19, 2011

(30) Foreign Application Priority Data
Nov. 12, 2010 (JP) 2010-253821

(51) Int. Cl. G09G 5/02

(52) U.S. Cl. 345/589

(57) ABSTRACT

At least one pixel having specific range color information in color information including at least one selected from the group including RGB values, a hue, a saturation, and a brightness is detected in a captured image captured by a real camera. When the pixel having the specific range color information has been detected, at least one of a shape, a position, and a display form of an object to be placed in a virtual world is changed on the basis of the color information of the pixel. Then, an image of the virtual world where at least the set object is placed is displayed on a display device.

### CROSS REFERENCE TO RELATED APPLICATION

The disclosure of Japanese Patent Application No. 2010-253821, filed on Nov. 12, 2010, is incorporated herein by reference.

### BACKGROUND OF THE INVENTION

1. Field of the Invention

The present invention relates to a storage medium having stored thereon a display control program, a display control apparatus, a display control system, and a display control method, and in particular, relates to a storage medium having stored thereon a display control program that sets and controls the display of a virtual object, using a real world image, and a display control apparatus, a display control system, and a display control method that set and control the display of a virtual object, using a real world image.

2. Description of the Background Art

Conventionally, as disclosed in, for example, Japanese Laid-Open Patent Publication No. 2008-113746 (hereinafter referred to as “Patent Literature I”), a proposal is made for an apparatus that displays an image obtained by overlapping a real world image and a virtual world image. A game apparatus disclosed in Patent Literature 1 displays an image, captured by an outer camera, as a background image so as to overlap a game image. Specifically, the game apparatus updates the background image at regular time intervals, and displays the most recent background image so as to overlap the game image.

The game apparatus disclosed in Patent Literature 1, however, merely displays the image captured by the outer camera as the background image. In this case, the overlapping background image and game image are displayed in the state where they are not related to each other at all. Thus, the displayed image per se is monotonous, and therefore, it is not possible to present an interesting image to a user.

### SUMMARY OF THE INVENTION

Therefore, it is an object of the present invention to provide a storage medium having stored thereon a display control program capable of setting and controlling the display of a new image, using a real world image, and a display control apparatus, a display control system, and a display control method that are capable of setting and controlling the display of a new image, using a real world image.

To achieve the above object, the present invention may employ, for example, the following configurations. It is understood that when the description of the scope of the appended claims is interpreted, the scope should be interpreted only by the description of the scope of the appended claims. If the description of the scope of the appended claims contradicts the description of these columns, the description of the scope of the appended claims has priority.

An example of the configuration of a computer-readable storage medium having stored thereon a display control program according to the present invention is executed by a computer of a display control apparatus that displays an image on a display device. The display control program causes the computer to function as captured image acquisition means, color detection means, object setting means, and image display control means. The captured image acquisition means acquires a captured image captured by a real camera. The color detection means, in the captured image acquired by the captured image acquisition means, detects at least one pixel having specific range color information in color information including at least one selected from the group including RGB values, a hue, a saturation, and a brightness. The object setting means, when the color detection means has detected the pixel having the specific range color information, changes, on the basis of the color information of the pixel, at least one of a shape, a position, and a display form of an object to be placed in a virtual world. The image display control means displays on the display device an image of the virtual world where at least the object set by the object setting means is placed.

Based on the above, when a pixel having specific range color information has been detected in a captured image captured by a real camera, an object changes in accordance with the color information when displayed. This makes it possible to set and control the display of a new image, using a real world image.

In addition, the display control program may further cause the computer to function as image combination means. The image combination means generates a combined image obtained by combining the captured image acquired by the captured image acquisition means with the image of the virtual world where the object is placed. In this case, the image display control means may display the combined image generated by the image combination means on the display device.

Based on the above, display is performed such that the captured image (the real world image) and an image in which the object is placed (a virtual world image) are combined together. This makes it possible to present a more interesting image.

In addition, when the image combination means combines the captured image with the image of the virtual world such that the object is combined with the captured image so as to overlap the pixel having the specific range color information, the object setting means may change at least one of the shape, the position, and the display form of the object on the basis of the color information of the pixel.

Based on the above, the object is to change in a virtual space so as to correspond to the position of the pixel having the specific range color information detected from the captured image. This requires a user to perform an operation of overlapping an object to change and a specific-colored subject, and this makes it possible to provide a new operation environment.

In addition, when the image combination means combines the captured image with the image of the virtual world such that the object is combined with the captured image so as to overlap a pixel having items of the color information indicating the saturation and the brightness that are equal to or greater than predetermined thresholds, respectively, and also having an item of the color information indicating the hue indicative of a value within a predetermined range, the object setting means may change at least one of the shape, the position, and the display form of the object on the basis of the color information of the pixel.

Based on the above, the setting of the object by combining a plurality of items of color information makes it possible to bring the result of the object settings to the color recognition normally performed by the user, while preventing erroneous color determinations.

In addition, in accordance with the saturation or the brightness of the pixel, the object setting means may set: an amount of change in shape by which the shape of the object to be combined with the captured image so as to overlap the pixel is changed; an amount of change in position by which the position of the object is changed; and a velocity of change by which the display form of the object is changed.

Based on the above, the amount of change and the velocity of change, by which the object is changed, change in accordance with the saturation or the brightness. This makes it possible to display a variety of changes in the object.

In addition, the display control program may further cause the computer to function as operation target object setting means. The operation target object setting means further places in the virtual world an operation target object capable of moving in the virtual world while making contact with at least part of the object set by the object setting means, the operation target object being different from the object. In this case, the object setting means may change the shape or the position of the object to be combined with the captured image so as to overlap the pixel. The image display control means may display on the display device an image of the virtual world where the operation target object set by the operation target object setting means is placed in addition to the object set by the object setting means.

Based on the above, it is possible to achieve a game where an operation target object different from the object is moved in accordance with a change in the object.

In addition, when the image combination means combines the captured image with the image of the virtual world, the object setting means may set the shape and the position of an object to be combined with the captured image so as not to overlap the pixel having the specific range color information, to a reference shape and a reference position, respectively, and may deform the shape of, or move the position of, an object to be combined with the captured image so as to overlap the pixel having the specific range color information, from the reference shape or the reference position, respectively.

Based on the above, it is possible to display an interesting image in which, among objects placed at reference positions, only an object overlapping the pixel having the specific range color information deforms or moves.

In addition, the operation target object setting means may move the operation target object in the virtual world in accordance with the shape or the position of the object changed by the object setting means.

Based on the above, it is possible to achieve a game where the different operation target object moves in the virtual world in accordance with a change in the shape or the position of the object.

In addition, the object setting means: may default the shape of the object to be combined with the captured image so as to overlap the pixel having the specific range color information, such that the shape is enlarged or reduced in a vertical direction from the reference shape; or may move the position of the object such that the position rises or falls from the reference position. In this case, the operation target object setting means may place the operation target object on one of upper surfaces of a plurality of objects set by the object setting means, and may move the operation target object in the virtual world on the basis of differences in height between the upper surfaces of the plurality of objects.

Based on the above, the operation target object placed on a plurality of objects moves in accordance with the differences in height between the objects, and only an object overlapping the pixel having the specific range color information deforms or moves. It is possible to achieve a new game where the operation target object is moved by displaying a specific-colored subject and the objects so as to overlap each other.

In addition, the object setting means may change the shape of the object to be combined with the captured image so as to overlap the pixel, by causing the object to extend or contract on the basis of the color information of the pixel.

Based on the above, it is possible to display an interesting image by causing an object overlapping the pixel having the specific range color information to extend or contract.

In addition, the display control program may further cause the computer to function as fixed object setting means. The fixed object setting means further sets a plurality of fixed objects in a fixed manner at predetermined reference positions in the virtual world. In this case, when the image combination means combines the captured image with the image of the virtual world, the object setting means may place, at a position different in height from the reference positions, an object to be combined with the captured image so as not to overlap the pixel having the specific range color information, and may place, at substantially the same height as the heights of the reference positions, an object to be combined with the captured image so as to overlap the pixel having the specific range color information. The image display control means may display on the display device an image of the virtual world where the plurality of fixed objects set by the fixed object setting means are placed in addition to the object set by the object setting means.

Based on the above, an object placed at a position different in height from reference positions may overlap the pixel having the specific range color information, and thereby rises or falls to a position substantially the same height as those of fixed objects. This makes it possible to display an interesting image.

In addition, the display control program may further cause the computer to function as fixed object setting means. The fixed object setting means further sets a plurality of fixed objects in a fixed manner at predetermined reference positions in the virtual world. In this case, the object setting means may move an object to be combined with the captured image so as to overlap the pixel having the specific range color information, such that the object goes back and forth within a gap between the plurality of fixed objects and at substantially the same height as heights of the reference positions. The image display control means may display on the display device an image of the virtual world where the fixed objects set by the fixed object setting means are placed in addition to the object set by the object setting means.

Based on the above, an object placed at a position different in height from reference positions may overlap the pixel having the specific range color information, and thereby goes back and forth within a gap between fixed objects and at substantially the same height as those of the reference positions. This makes it possible to display an interesting image.

In addition, the display control program may further cause the computer to function as operation target object setting means. The operation target object setting means may further place in the virtual world an operation target object capable of, in accordance with an operation of a user, moving on the object placed at substantially the same height as the heights of the reference positions and on the fixed objects, the operation target object being different from the object and the fixed objects. In this case, the image display control means may display on the display device an image of the virtual world where the operation target object set by the operation target object setting means is placed in addition to the object set by the object setting means and the fixed objects set by the fixed object setting means.

Based on the above, in a game where an operation target object is capable of moving only on the object placed substantially the same height as those of the reference positions, when a gap across which the operation target object is incapable of jumping is formed, and an object capable of being placed in the gap is set, it is possible to pass through the gap by overlapping the object and the pixel having the specific range color information.

In addition, the color detection means may calculate the color information to be used in a current detection process, by interpolating the color information of a currently acquired captured image with the color information calculated in a previous process.

Based on the above, it is possible to prevent a rapid change in at least one of the shape, the position, and the display form of the object, the rapid change caused by a rapid change in color in the captured image.

In addition, the object setting means may set a color of the object, on the basis of which at least one of the shape, the position, and the display form of the object is to be changed, to a complementary color of a color of the pixel having the specific range color information.

Based on the above, by the color of the object, a user can understand the color of a subject, on the basis of which a change is to occur.

In addition, the display control program further cause the computer to function as object movement control means. The object movement control means, in accordance with an operation of a user, moves in the virtual world the object set by the object setting means. In this case, when the object controlled to move by the object movement control means is combined with the captured image so as to overlap the pixel, the object setting means may increase or decrease, on the basis of the color information of the pixel, a velocity at which the object movement control means moves the object.

Based on the above, the object capable of being operated by the user may overlap a specific-colored subject, whereby the moving velocity of the object increases or decreases. This increases the level of difficulty of the operation. Further, when the user desires to increase or decrease the moving velocity of the object, the user needs to perform an operation of overlapping a specific-colored subject and the object. This makes it possible to provide a new operation environment.

In addition, the color detection means may include block division means and block RGB average value calculation means. The block division means divides the captured image into blocks each including a plurality of pixels. The block RGB average value calculation means calculates average values of RGB values of pixels included in each block. In this case, the color detection means may detect at least one pixel having the specific range color information, on the basis of the average values of each block.

Based on the above, the determination of the color information on a block-by-block basis facilitates a color detection process, and therefore reduces the processing load.

In addition, the captured image acquisition means may repeatedly acquire captured images of a real world captured in real time by a real camera available to the display control apparatus. In this case, the color detection means may repeatedly detect pixels having the specific range color information in the captured images, respectively, repeatedly acquired by the captured image acquisition means. The object setting means may repeatedly change at least one of the shape, the position, and the display form of the object on the basis of the color information repeatedly detected by the color detection means. The image combination means may repeatedly generate combined images by combining each of the captured images repeatedly acquired by the captured image acquisition means, with the image of the virtual world where the object is placed. The image display control means may repeatedly display on the display device the combined images obtained by combining each of the captured images repeatedly acquired by the captured image acquisition means, with the image of the virtual world.

Based on the above, the pixel having the specific range color information is detected from the captured image of the real world captured in real time, and display is performed such that an object corresponding to the color information is changed when combined with the captured image. This makes it possible to set and control the display of a new image, using a real world image obtained in real time.

In addition, when the image combination means combines the captured image with the image of the virtual world such that the object is combined with the captured image so as to overlap the pixel having the specific range color information, and subsequently further combined with the captured image so as to overlap a pixel having color information of a range different from the specific range, the object setting means may change at least one of the shape, the position, and the display form of the object.

Based on the above, to change at least one of the shape, the position, and the display form of the object, it is necessary to overlap the object and two subjects having specific colors different from each other. This increases the level of difficulty of the operation to be performed by the user, and this makes it possible to provide a new operation environment.

In addition, the present invention may be carried out in the form of a display control apparatus and a display control system that include the above means, and may be carried out in the form of a display control method including operations performed by the above means.

Based on the present invention, a pixel having specific range color information is detected from a captured image captured by a real camera, and at least one of the shape, the position, and the display form of an object corresponding to the color information is changed when the object is displayed. This makes it possible to set and control the display of a new image, using a real world image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an example of a game apparatus 10 being open;

FIG. 2 is a right side view showing an example of the game apparatus 10 being open;

FIG. 3A is a left side view showing an example of the game apparatus 10 being closed;

FIG. 3B is a front view showing an example of the game apparatus 10 being closed;

FIG. 3C is a right side view showing an example of the game apparatus 10 being closed;

FIG. 3D is a rear view showing an example of the game apparatus 10 being closed;

FIG. 4 is a diagram showing an example of a user holding the game apparatus 10 with both hands;

FIG. 5 is a block diagram showing an example of the internal configuration of the game apparatus 10;

FIG. 6A is a diagram showing an example where in a first game example, display is performed on an upper LCD 22 such that a virtual world image is combined with a camera image CI;

FIG. 6B is a diagram showing an example where in the first game example, display is performed on the upper LCD 22 such that a red subject included in the camera image CI and virtual objects are displayed so as to overlap each other;

FIG. 7A is a diagram showing an example where in a second game example, display is performed on the upper LCD 22 such that a virtual world image is combined with the camera image CI;

FIG. 7B is a diagram showing an example where in the second game example, display is performed on the upper LCD 22 such that a red subject included in the camera image CI and virtual objects are displayed so as to overlap each other;

FIG. 8A is a diagram showing an example where in a third game example, display is performed on the upper LCD 22 such that a virtual world image is combined with the camera image CI;

FIG. 8B is a diagram showing an example where in the third game example, display is performed on the upper LCD 22 such that a red subject included in the camera image CI and virtual objects are displayed so as to overlap each other;

FIG. 9 is a diagram showing an example of various data stored in a main memory 32 in accordance with the execution of a display control program;

FIG. 10 is a diagram showing an example of block RGB data Db of FIG. 9;

FIG. 11 is a diagram showing an example of cube color data Dc of FIG. 9;

FIG. 12 is a flow chart showing an example of the operation of display control processing performed by the game apparatus 10 in accordance with the execution of the display control program;

FIG. 13 is a subroutine flow chart showing an example of a detailed operation of an object setting process performed in step 53 of FIG. 12;

FIG. 14 is a subroutine flow chart showing an example of a detailed operation of a cube length calculation process performed in step 72 of FIG. 13;

FIG. 15 is a diagram illustrating an example of a process of rendering a plurality of cubes CB and a ball object BL;

FIG. 16A is a diagram showing an example where in a fourth game example, display is performed on the upper LCD 22 such that a virtual world image is combined with the camera image CI; and

FIG. 16B is a diagram showing an example where in the fourth game example, display is performed on the upper LCD 22 such that a blue subject included in the camera image CI and virtual objects are displayed so as to overlap each other.

### DESCRIPTION OF THE PREFERRED EMBODIMENTS

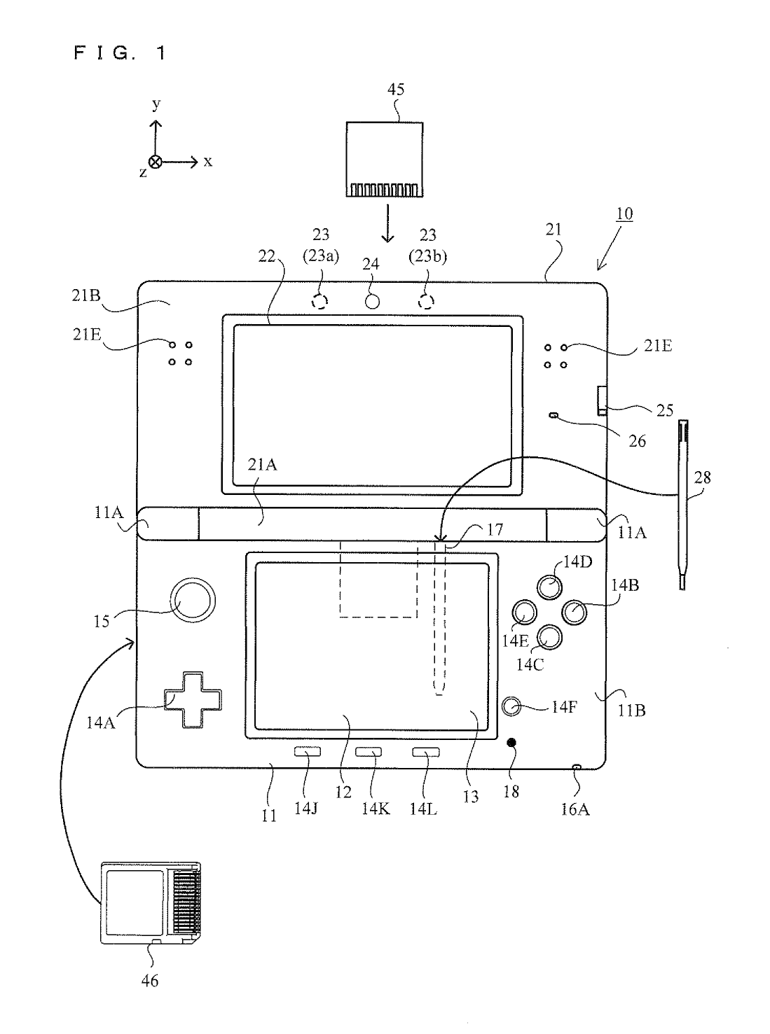

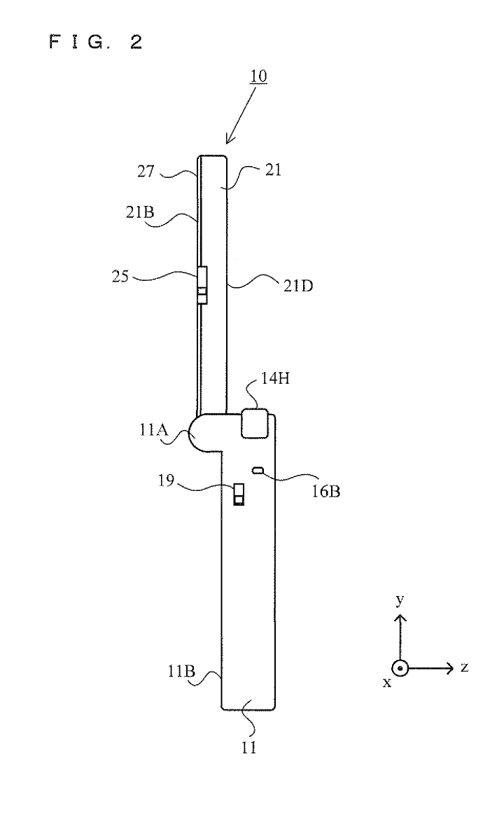

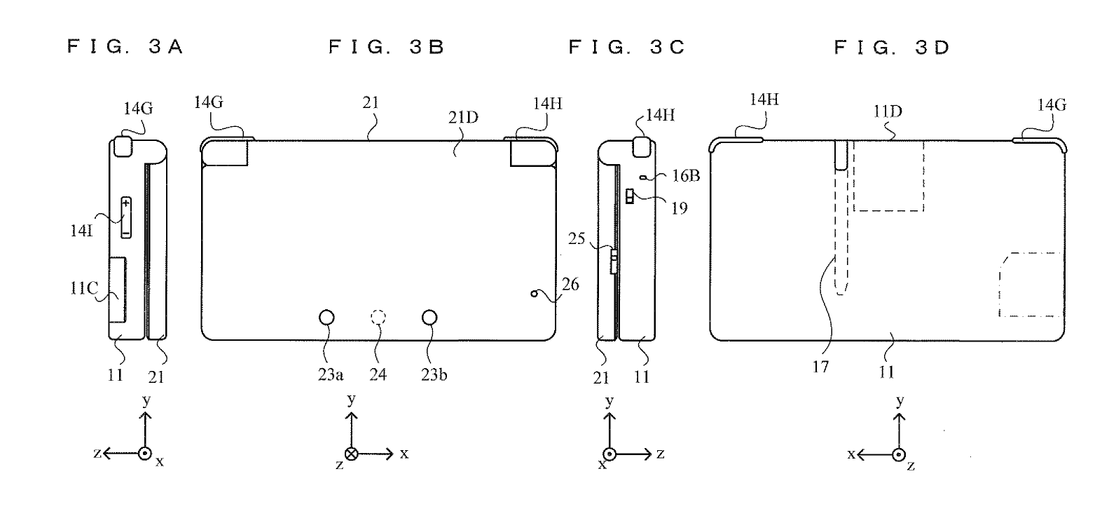

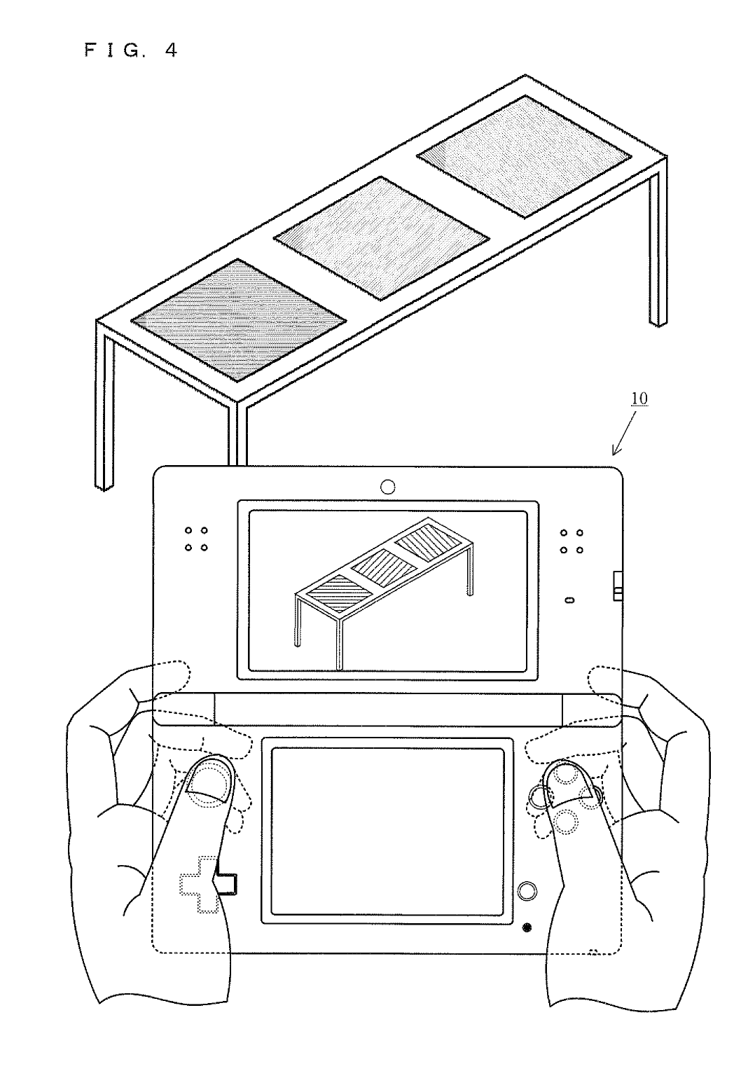

With reference to the drawings, a description is given of an image control apparatus that executes an image control program according to an embodiment of the present invention. The image control program according to the present invention can be applied by being executed by a given computer system. As an example of the image control apparatus, a hand-held game apparatus 10 is taken, and the description is given using the image control program executed by the game apparatus 10. It should be noted that FIGS. 1 through 3D are each a plan view showing an example of the outer appearance of the game apparatus 10. As an example, the game apparatus 10 is a hand-held game apparatus, and is configured to be foldable as shown in FIGS. 1 through 3D. FIG. 1 is a front view showing an example of the game apparatus 10 being open (in an open state). FIG. 2 is a right side view showing an example of the game apparatus 10 in the open state. FIG. 3A is a left side view showing an example of the game apparatus 10 being closed (in a closed state). FIG. 3B is a front view showing an example of the game apparatus 10 in the closed state. FIG. 3C is a right side view showing an example of the game apparatus 10 in the closed state. FIG. 3D is a rear view showing an example of the game apparatus 10 in the closed state. The game apparatus 10 includes capturing sections, and is capable, for example, of capturing an image with the capturing sections, displaying the captured image on a screen, and storing data of the captured image. The game apparatus 10 is capable of executing a game program stored in an exchangeable memory card, or received from a server or another game apparatus, and is also capable of displaying on the screen an image generated by computer graphics processing, such as a virtual world image viewed from a virtual camera set in a virtual space.

In FIGS. 1 through 3D, the game apparatus 10 includes a lower housing 11 and an upper housing 21. The lower housing 11 and the upper housing 21 are joined together so as to be openable and closable in a folding manner (foldable). In the example of FIG. 1, the lower housing 11 and the upper housing 21 each have a wider-than-high rectangular plate-like shape, and are joined together at one of the long sides of the lower housing 11 and the corresponding one of the long sides of the upper housing 21 so as to be pivotable relative to each other. Normally, a user uses the game apparatus 10 in the open state. The user stores away the game apparatus 10 in the closed state when not using it. Further, as well as the closed state and the open state that are described above, the game apparatus 10 can maintain the lower housing 11 and the upper housing 21 at a given angle formed between the game apparatus 10 in the closed state and the game apparatus 10 in the open state due, for example, to a frictional force generated at the connecting part. That is, the upper housing 21 can be maintained stationary at a given angle with respect to the lower housing 11.

As shown in FIGS. 1 and 2, projections 11A are provided at the upper long side portion of the lower housing 11, the projections 11A projecting perpendicularly to an inner surface (main surface) 1113 of the lower housing 11. A projection 21A is provided at the lower long side portion of the upper housing 21, the projection 21A projecting perpendicularly to the lower side surface of the upper housing 21 from the lower side surface of the upper housing 21. The joining of the projections 11A of the lower housing 11 and the projection 21A of the upper housing 21 connects the lower housing 11 and the upper housing 21 together in a foldable manner.

The lower housing 11 includes a lower liquid crystal display (LCD) 12, a touch panel 13, operation buttons 14A through 14L (FIG. 1, FIGS. 3A through 3D), an analog stick 15, LEDs 16A and 16B, an insertion slot 17, and a microphone hole 18. These components are described in detail below.

As shown in FIG. 1, the lower LCD 12 is accommodated in the lower housing 11. The lower LCD 12 has a wider-than-high shape, and is placed such that the long side direction of the lower LCD 12 coincides with the long side direction of the lower housing 11. The lower LCD 12 is placed at the center of the lower housing 11. The lower LCD 12 is provided on the inner surface (main surface) of the lower housing 11, and the screen of the lower LCD 12 is exposed through an opening provided in the inner surface of the lower housing 11. The game apparatus 10 is in the closed state when not used, so that the screen of the lower LCD 12 is prevented from being soiled or damaged. As an example, the number of pixels of the lower LCD 12 is 256 dots×192 dots (horizontal×vertical). As another example, the number of pixels of the lower LCD 12 is 320 dots×240 dots (horizontal×vertical). Unlike the upper LCD 22 described later, the lower LCD 12 is a display device that displays an image in a planar manner (not in a stereoscopically visible manner). It should be noted that although an LCD is used as a display device in the present embodiment, another given display device may be used, such as a display device using electroluminescence (EL). Further, a display device having a given resolution may be used as the lower LCD 12.

As shown in FIG. 1, the game apparatus 10 includes the touch panel 13 as an input device. The touch panel 13 is mounted so as to cover the screen of the lower LCD 12. In the present embodiment, the touch panel 13 may be, but is not limited to, a resistive touch panel. The touch panel may also be a touch panel of any pressure type, such as an electrostatic capacitance type. In the present embodiment, the touch panel 13 has the same resolution (detection accuracy) as that of the lower LCD 12. The resolutions of the touch panel 13 and the lower LCD 12, however, may not necessarily need to coincide with each other. Further, the insertion slot 17 (a dashed line shown in FIGS. 1 and 3D) is provided on the upper side surface of the lower housing 11. The insertion slot 17 can accommodate a stylus 28 that is used to perform an operation on the touch panel 13. Although an input on the touch panel 13 is normally provided using the stylus 28, an input may be provided on the touch panel 13 not only by the stylus 28 but also by a finger of the user.

The operation buttons 14A through 14L are each an input device for providing a predetermined input. As shown in FIG. 1, among the operation buttons 14A through 14L, the cross button 14A (direction input button 14A), the button 14B, the button 14C, the button 14D, the button 14E, the power button 14F, the select button 14J, the home button 14K, and the start button 14L are provided on the inner surface (main surface) of the lower housing 11. The cross button 14A is cross-shaped, and includes buttons for indicating up, down, left, and right directions, respectively. The button 14B, the button 14C, the button 14D, and the button 14E are placed in a cross formation. The buttons 14A through 14E, the select button 14J, the home button 14K, and the start button 14L are appropriately assigned functions, respectively, in accordance with the program executed by the game apparatus 10. The cross button 14A is used for, for example, a selection operation. The operation buttons 14B through 14E are used for, for example, a determination operation or a cancellation operation. The power button 14F is used to power on/off the game apparatus 10.

The analog stick 15 is a device for indicating a direction, and is provided in the upper left region of the lower LCD 12 of the inner surface of the lower housing 11. As shown in FIG. 1, the cross button 14A is provided in the lower left region of the lower LCD 12 of the lower housing 11 such that the analog stick 15 is provided above the cross button 14A. The analog stick 15 and the cross button 14A are placed so as to be operated by the thumb of a left hand holding the lower housing 11. Further, the provision of the analog stick 15 in the upper region places the analog stick 15 at the position where the thumb of a left hand holding the lower housing 11 is naturally placed, and also places the cross button 14A at the position where the thumb of the left hand is moved slightly downward from the analog stick 15. The key top of the analog stick 15 is configured to slide parallel to the inner surface of the lower housing 11. The analog stick 15 functions in accordance with the program executed by the game apparatus 10. When, for example, the game apparatus 10 executes a game where a predetermined object appears in a three-dimensional virtual space, the analog stick 15 functions as an input device for moving the predetermined object in the three-dimensional virtual space. In this case, the predetermined object is moved in the direction in which the key top of the analog stick 15 has slid. It should be noted that the analog stick 15 may be a component capable of providing an analog input by being tilted by a predetermined amount in any one of up, down, right, left, and diagonal directions.

The four buttons placed in a cross formation, namely, the button 14B, the button 14C, the button 14D, and the button 14E, are placed at the positions where the thumb of a right hand holding the lower housing 11 is naturally placed. Further, these four buttons and the analog stick 15 are placed symmetrically to each other with respect to the lower LCD 12. This also enables, for example, a left-handed person to provide a direction indication input using these four buttons, depending on the game program.

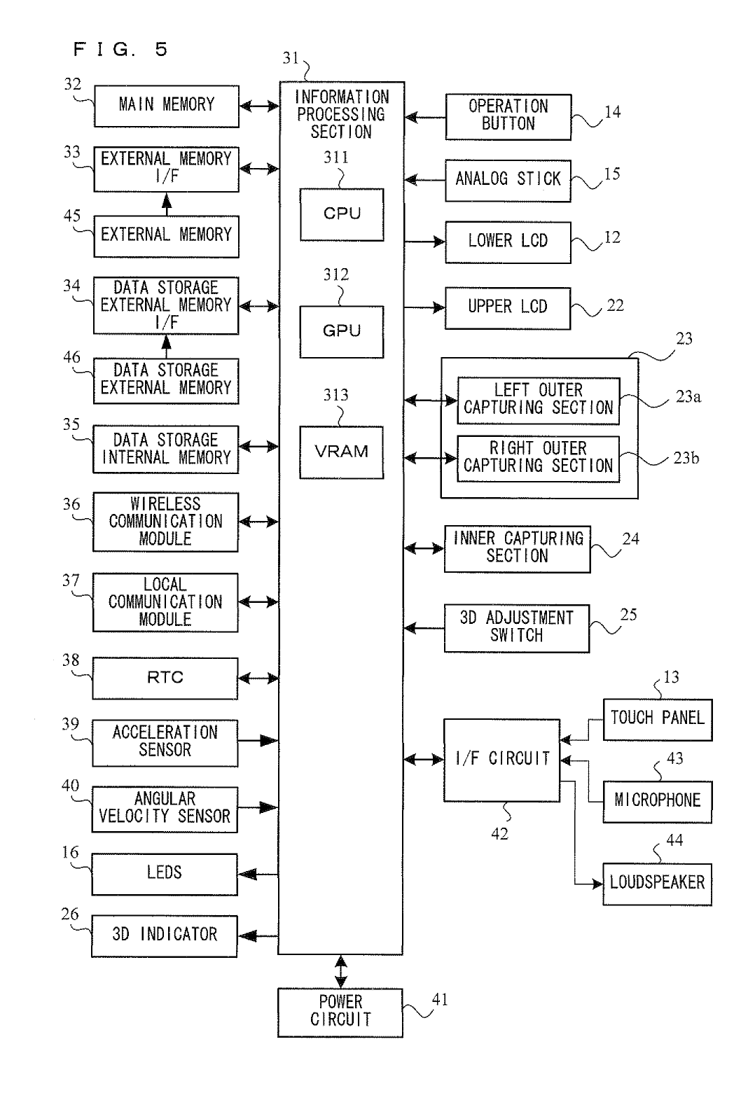

Further, the microphone hole 18 is provided on the inner surface of the lower housing 11. Underneath the microphone hole 18, a microphone (see FIG. 5) is provided as the sound input device described later, and detects sound from outside the game apparatus 10.

As shown in FIGS. 3B and 3D, the L button 14G and the R button 14H are provided on the upper side surface of the lower housing 11. The L button 14G is provided at the left end portion of the upper side surface of the lower housing 11, and the R button 14H is provided at the right end portion of the upper side surface of the lower housing 11. As described later, the L button 14G and the R button 14H function as shutter buttons (capturing instruction buttons) of the capturing sections. Further, as shown in FIG. 3A, the sound volume button 14I is provided on the left side surface of the lower housing 11. The sound volume button 14I is used to adjust the sound volume of a loudspeaker of the game apparatus 10.

As shown in FIG. 3A, a cover section 11C is provided on the left side surface of the lower housing 11 so as to be openable and closable. Within the cover section 11C, a connector (not shown) is provided for electrically connecting the game apparatus 10 and a data storage external memory 46 together. The data storage external memory 46 is detachably attached to the connector. The data storage external memory 46 is used to, for example, record (store) data of an image captured by the game apparatus 10. It should be noted that the connector and the cover section 11C may be provided on the right side surface of the lower housing 11.

As shown in FIG. 3D, on the upper side surface of the lower housing 11, an insertion slot 11D is provided, into which an external memory 45 having a game program stored thereon is to be inserted. Within the insertion slot 11D, a connector (not shown) is provided for electrically connecting the game apparatus 10 and the external memory 45 together in a detachable manner. A predetermined game program is executed by connecting the external memory 45 to the game apparatus 10. It should be noted that the connector and the insertion slot 11D may be provided on another side surface (e.g., the right side surface) of the lower housing 11.

As shown in FIG. 1, on the lower side surface of the lower housing 11, the first LED 16A is provided for notifying the user of the on/off state of the power supply of the game apparatus 10. Further, as shown in FIG. 3C, on the right side surface of the lower housing 11, the second LED 16B is provided for notifying the user of the establishment state of the wireless communication of the game apparatus 10. Furthermore, the game apparatus 10 is capable of wirelessly communicating with other devices, and the second LED 16B is lit on when wireless communication is established between the game apparatus 10 and other devices. The game apparatus 10 has the function of establishing connection with a wireless LAN by, for example, a method based on the IEEE 802.11.b/g standard. On the right side surface of the lower housing 11, a wireless switch 19 is provided for enabling/disabling the function of the wireless communication (see FIG. 3C).

It should be noted that although not shown in the figures, a rechargeable battery that serves as the power supply of the game apparatus 10 is accommodated in the lower housing 11, and the battery can be charged through a terminal provided on the side surface (e.g., the upper side surface) of the lower housing 11.

The upper housing 21 includes an upper LCD 22, an outer capturing section 23 having two outer capturing sections (a left outer capturing section 23a and a right outer capturing section 23b), an inner capturing section 24, a 3D adjustment switch 25, and a 3D indicator 26. These components are described in detail below.

As shown in FIG. 1, the upper LCD 22 is accommodated in the upper housing 21. The upper LCD 22 has a wider-than-high shape, and is placed such that the long side direction of the upper LCD 22 coincides with the long side direction of the upper housing 21. The upper LCD 22 is placed at the center of the upper housing 21. As an example, the area of the screen of the upper LCD 22 is set greater than that of the lower LCD 12. Specifically, the screen of the upper LCD 22 is set horizontally longer than the screen of the lower LCD 12. That is, the proportion of the width in the aspect ratio of the screen of the upper LCD 22 is set greater than that of the lower LCD 12.

The screen of the upper LCD 22 is provided on the inner surface (main surface) 21B of the upper housing 21, and is exposed through an opening provided in the inner surface of the upper housing 21. Further, as shown in FIG. 2, the inner surface of the upper housing 21 is covered by a transparent screen cover 27. The screen cover 27 protects the screen of the upper LCD 22, and integrates the upper LCD 22 and the inner surface of the upper housing 21, and thereby provides unity. As an example, the number of pixels of the upper LCD 22 is 640 dots×200 dots (horizontal×vertical). As another example, the number of pixels of the upper LCD 22 is 800 dots×240 dots (horizontal×vertical). It should be noted that although an LCD is used as the upper LCD 22 in the present embodiment, a display device using EL or the like may be used. Furthermore, a display device having a given resolution may be used as the upper LCD 22.

The upper LCD 22 is a display device capable of displaying a stereoscopically visible image. The upper LCD 22 is capable of displaying a left-eye image and a right-eye image, using substantially the same display region. Specifically, the upper LCD 22 is a display device using a method in which the left-eye image and the right-eye image are displayed alternately in the horizontal direction in predetermined units (e.g., in every other line). As an example, if the number of pixels of the upper LCD 22 is 800 dots×240 dots, the horizontal 800 pixels may be alternately assigned to the left-eye image and the right-eye image such that each image is assigned 400 pixels, whereby the resulting image is stereoscopically visible. It should be noted that the upper LCD 22 may be a display device using a method in which the left-eye image and the right-eye image are displayed alternately for a predetermined time. Further, the upper LCD 22 is a display device capable of displaying an image stereoscopically visible with the naked eye. In this case, a lenticular type display device or a parallax barrier type display device is used so that the left-eye image and the right-eye image that are displayed alternately in the horizontal direction can be viewed separately with the left eye and the right eye, respectively. In the present embodiment, the upper LCD 22 is of a parallax barrier type. The upper LCD 22 displays an image stereoscopically visible with the naked eye (a stereoscopic image), using the right-eye image and the left-eye image. That is, the upper LCD 22 allows the user to view the left-eye image with their left eye, and the right-eye image with their right eye, using the parallax barrier. This makes it possible to display a stereoscopic image giving the user a stereoscopic effect (a stereoscopically visible image). Furthermore, the upper LCD 22 is capable of disabling the parallax barrier. When disabling the parallax barrier, the upper LCD 22 is capable of displaying an image in a planar manner (the upper LCD 22 is capable of displaying a planar view image, as opposed to the stereoscopically visible image described above. This is a display mode in which the same displayed image can be viewed with both the left and right eyes.). Thus, the upper LCD 22 is a display device capable of switching between: the stereoscopic display mode for displaying a stereoscopically visible image; and the planar display mode for displaying an image in a planar manner (displaying a planar view image). The switching of the display modes is performed by the 3D adjustment switch 25 described later.

The “outer capturing section 23” is the collective term of the two capturing sections (the left outer capturing section 23a and the right outer capturing section 23b) provided on an outer surface (the back surface, which is the opposite side to the main surface including the upper LCD 22) 21D of the upper housing 21. The capturing directions of the left outer capturing section 23a and the right outer capturing section 23b are each the same as the outward normal direction of the outer surface 21D. Further, the left outer capturing section 23a and the right outer capturing section 23b are each designed so as to be placed 180 degrees opposite to the normal direction of the display surface (inner surface) of the upper LCD 22. That is, the capturing direction of the left outer capturing section 23a and the capturing direction of the right outer capturing section 23b are parallel to each other. The left outer capturing section 23a and the right outer capturing section 23b can be used as a stereo camera, depending on the program executed by the game apparatus 10. Alternatively, either one of the two outer capturing sections (the left outer capturing section 23a and the right outer capturing section 23b) may be used solely, so that the outer capturing section 23 can also be used as a non-stereo camera, depending on the program. Yet alternatively, depending on the program, images captured by the two outer capturing sections (the left outer capturing section 23a and the right outer capturing section 23b) may be combined together, or may be used to compensate for each other, so that capturing can be performed with an extended capturing range. In the present embodiment, the outer capturing section 23 includes two capturing sections, namely, the left outer capturing section 23a and the right outer capturing section 23b. The left outer capturing section 23a and the right outer capturing section 23b each include an imaging device (e.g., a CCD image sensor or a CMOS image sensor) having a predetermined common resolution, and a lens. The lens may have a zoom mechanism.

As indicated by dashed lines in FIG. 1 and solid lines in FIG. 3B, the left outer capturing section 23a and the right outer capturing section 23b included in the outer capturing section 23 are placed parallel to the horizontal direction of the screen of the upper LCD 22. That is, the left outer capturing section 23a and the right outer capturing section 23b are placed such that a straight line connecting between the left outer capturing section 23a and the right outer capturing section 23b is parallel to the horizontal direction of the screen of the upper LCD 22. The dashed lines 23a and 23b in FIG. 1 indicate the left outer capturing section 23a and the right outer capturing section 23b, respectively, provided on the outer surface, which is the opposite side of the inner surface of the upper housing 21. As shown in FIG. 1, when the user views the screen of the upper LCD 22 from the front thereof, the left outer capturing section 23a is placed to the left of the upper LCD 22, and the right outer capturing section 23b is placed to the right of the upper LCD 22. When a program is executed that causes the outer capturing section 23 to function as a stereo camera, the left outer capturing section 23a captures a left-eye image, which is to be viewed with the user's left eye, and the right outer capturing section 23b captures a right-eye image, which is to be viewed with the user's right eye. The distance between the left outer capturing section 23a and the right outer capturing section 23b is set to correspond to the distance between both eyes of a person, and may be set, for example, in the range of from 30 mm to 70 mm. The distance between the left outer capturing section 23a and the right outer capturing section 23b, however, is not limited to this range.

It should be noted that in the present embodiment, the left outer capturing section 23a and the right outer capturing section 23b are fixed to the housing, and therefore, the capturing directions cannot be changed.

The left outer capturing section 23a and the right outer capturing section 23b are placed symmetrically to each other with respect to the center of the upper LCD 22 (the upper housing 21) in the left-right direction. That is, the left outer capturing section 23a and the right outer capturing section 23b are placed symmetrically with respect to the line dividing the upper LCD 22 into two equal left and right parts. Further, the left outer capturing section 23a and the right outer capturing section 23b are placed in the upper portion of the upper housing 21 and in the back of the portion above the upper end of the screen of the upper LCD 22, in the state where the upper housing 21 is in the open state. That is, the left outer capturing section 23a and the right outer capturing section 23b are placed on the outer surface of the upper housing 21, and, if the upper LCD 22 is projected onto the outer surface of the upper housing 21, is placed above the upper end of the screen of the projected upper LCD 22.

Thus, the two capturing sections (the left outer capturing section 23a and the right outer capturing section 23b) of the outer capturing section 23 are placed symmetrically with respect to the center of the upper LCD 22 in the left-right direction. This makes it possible that when the user views the upper LCD 22 from the front thereof, the capturing directions of the outer capturing section 23 coincide with the directions of the respective lines of sight of the user's right and left eyes. Further, the outer capturing section 23 is placed in the back of the portion above the upper end of the screen of the upper LCD 22, and therefore, the outer capturing section 23 and the upper LCD 22 do not interfere with each other inside the upper housing 21. This makes it possible to reduce the upper housing 21 in thickness as compared to the case where the outer capturing section 23 is placed in the back of the screen of the upper LCD 22.

The inner capturing section 24 is provided on the inner surface (main surface) 21B of the upper housing 21, and functions as a capturing section having a capturing direction that is the same as the inward normal direction of the inner surface 21B of the upper housing 21. The inner capturing section 24 includes an imaging device (e.g., a CCD image sensor or a CMOS image sensor) having a predetermined resolution, and a lens. The lens may have a zoom mechanism.

As shown in FIG. 1, when the upper housing 21 is in the open state, the inner capturing section 24 is placed: in the upper portion of the upper housing 21; above the upper end of the screen of the upper LCD 22; and in the center of the upper housing 21 in the left-right direction (on the line dividing the upper housing 21 (the screen of the upper LCD 22) into two equal left and right parts). Specifically, as shown in FIGS. 1 and 3B, the inner capturing section 24 is placed on the inner surface of the upper housing 21 and in the back of the middle portion between the left outer capturing section 23a and the right outer capturing section 23b. That is, if the left outer capturing section 23a and the right outer capturing section 23b provided on the outer surface of the upper housing 21 are projected onto the inner surface of the upper housing 21, the inner capturing section 24 is placed at the middle portion between the projected left outer capturing section 23a and the projected right outer capturing section 23b. The dashed line 24 shown in FIG. 3B indicates the inner capturing section 24 provided on the inner surface of the upper housing 21.

Thus, the inner capturing section 24 captures an image in the direction opposite to that of the outer capturing section 23. The inner capturing section 24 is provided on the inner surface of the upper housing 21 and in the back of the middle portion between the two capturing sections of the outer capturing section 23. This makes it possible that when the user views the upper LCD 22 from the front thereof, the inner capturing section 24 captures the user's face from the front thereof. Further, the left outer capturing section 23a and the right outer capturing section 23b do not interfere with the inner capturing section 24 inside the upper housing 21. This makes it possible to reduce the upper housing 21 in thickness.

The 3D adjustment switch 25 is a slide switch, and is used to switch the display modes of the upper LCD 22 as described above. The 3D adjustment switch 25 is also used to adjust the stereoscopic effect of a stereoscopically visible image (stereoscopic image) displayed on the upper LCD 22. As shown in FIGS. 1 through 3D, the 3D adjustment switch 25 is provided at the end portion shared by the inner surface and the right side surface of the upper housing 21, and is placed so as to be visible to the user when the user views the upper LCD 22 from the front thereof. The 3D adjustment switch 25 includes a slider that is slidable to a given position in a predetermined direction (e.g., the up-down direction), and the display mode of the upper LCD 22 is set in accordance with the position of the slider.

When, for example, the slider of the 3D adjustment switch 25 is placed at the lowermost position, the upper LCD 22 is set to the planar display mode, and a planar image is displayed on the screen of the upper LCD 22. It should be noted that the same image may be used as the left-eye image and the right-eye image, while the upper LCD 22 remains in the stereoscopic display mode, and thereby performs planar display. On the other hand, when the slider is placed above the lowermost position, the upper LCD 22 is set to the stereoscopic display mode. In this case, a stereoscopically visible image is displayed on the screen of the upper LCD 22. When the slider is placed above the lowermost position, the visibility of the stereoscopic image is adjusted in accordance with the position of the slider. Specifically, the amount of deviation in the horizontal direction between the position of the right-eye image and the position of the left-eye image is adjusted in accordance with the position of the slider.

The 3D indicator 26 indicates whether or not the upper LCD 22 is in the stereoscopic display mode. For example, the 3D indicator 26 is an LED, and is lit on when the stereoscopic display mode of the upper LCD 22 is enabled. As shown in FIG. 1, the 3D indicator 26 is placed on the inner surface of the upper housing 21 near the screen of the upper LCD 22. Accordingly, when the user views the screen of the upper LCD 22 from the front thereof, the user can easily view the 3D indicator 26. This enables the user to easily recognize the display mode of the upper LCD 22 even while viewing the screen of the upper LCD 22.

In addition, speaker holes 21E are provided on the inner surface of the upper housing 21. Sound from the loudspeaker 44 descried later is output through the speaker holes 21E.

Next, with reference to FIG. 4, an example is shown of the state of the use of the game apparatus 10. It should be noted that FIG. 4 is a diagram showing an example of a user operating the game apparatus 10 holding it.

As shown in FIG. 4, the user holds the side surfaces and the outer surface (the surface opposite to the inner surface) of the lower housing 11 with both palms, middle fingers, ring fingers, and little fingers, such that the lower LCD 12 and the upper LCD 22 face the user. Such holding enables the user to perform operations on the operation buttons 14A through 14E and the analog stick 15 with their thumbs, and to perform operations on the L button 14G and the R button 14H with their index fingers, while holding the lower housing 11. In the example shown in FIG. 4, on the upper LCD 22, a real world image is displayed that is obtained by capturing the real world on the back surface side of the game apparatus 10 with the left outer capturing section 23a and the right outer capturing section 23b. Further, when an input is provided on the touch panel 13, one of the hands having held the lower housing 11 is released therefrom, and the lower housing 11 is held only with the other hand. This makes it possible to provide an input on the touch panel 13 with the one hand.

Next, with reference to FIG. 5, a description is given of the internal configuration of the game apparatus 10. It should be noted that FIG. 5 is a block diagram showing an example of the internal configuration of the game apparatus 10.

Referring to FIG. 5, the game apparatus 10 includes, as well as the components described above, electronic components, such as an information processing section 31, a main memory 32, an external memory interface (external memory I/F) 33, a data storage external memory I/F 34, a data storage internal memory 35, a wireless communication module 36, a local communication module 37, a real-time clock (RTC) 38, an acceleration sensor 39, an angular velocity sensor 40, a power circuit 41, and an interface circuit (I/F circuit) 42. These electronic components are mounted on electronic circuit boards, and are accommodated in the lower housing 11 (or may be accommodated in the upper housing 21).

The information processing section 31 is information processing means including a central processing unit (CPU) 311 that executes a predetermined program, a graphics processing unit (GPU) 312 that performs image processing, and the like. In the present embodiment, a predetermined program is stored in a memory (e.g., the external memory 45 connected to the external memory I/F 33, or the data storage internal memory 35) included in the game apparatus 10. The CPU 311 of the information processing section 31 executes the predetermined program, and thereby performs display control processing described later or game processing. It should be noted that the program executed by the CPU 311 of the information processing section 31 may be acquired from another device by communication with said another device. The information processing section 31 further includes a video RAM (VRAM) 313. The GPU 312 of the information processing section 31 generates an image in accordance with an instruction from the CPU 311 of the information processing section 31, and draws the image in the VRAM 313. The GPU 312 of the information processing section 31 outputs the image drawn in the VRAM 313 to the upper LCD 22 and/or the lower LCD 12, and the image is displayed on the upper LCD 22 and/or the lower LCD 12.

To the information processing section 31, the main memory 32, the external memory I/F 33, the data storage external memory I/F 34, and the data storage internal memory 35 are connected. The external memory I/F 33 is an interface for establishing a detachable connection with the external memory 45. The data storage external memory I/F 34 is an interface for establishing a detachable connection with the data storage external memory 46.

The main memory 32 is volatile storage means used as a work area or a buffer area of the information processing section 31 (the CPU 311). That is, the main memory 32 temporarily stores various types of data used for display control processing or game processing, and also temporarily stores a program acquired from outside (the external memory 45, another device, or the like) the game apparatus 10. In the present embodiment, the main memory 32 is, for example, a pseudo SRAM (PSRAM).

The external memory 45 is nonvolatile storage means for storing the program executed by the information processing section 31. The external memory 45 is composed of, for example, a read-only semiconductor memory. When the external memory 45 is connected to the external memory I/F 33, the information processing section 31 can load a program stored in the external memory 45. In accordance with the execution of the program loaded by the information processing section 31, a predetermined process is performed. The data storage external memory 46 is composed of a readable/writable non-volatile memory (e.g., a NAND flash memory), and is used to store predetermined data. For example, the data storage external memory 46 stores images captured by the outer capturing section 23 and/or images captured by another device. When the data storage external memory 46 is connected to the data storage external memory I/F 34, the information processing section 31 loads an image stored in the data storage external memory 46, and is capable of causing the image to be displayed on the upper LCD 22 and/or the lower LCD 12.

The data storage internal memory 35 is composed of a readable/writable non-volatile memory (e.g., a NAND flash memory), and is used to store predetermined data. For example, the data storage internal memory 35 stores data and/or programs downloaded by wireless communication through the wireless communication module 36.

The wireless communication module 36 has the function of establishing connection with a wireless LAN by, for example, a method based on the IEEE 802.11.b/g standard. Further, the local communication module 37 has the function of wirelessly communicating with another game apparatus of the same type by a predetermined communication method (e.g., infrared communication). The wireless communication module 36 and the local communication module 37 are connected to the information processing section 31. The information processing section 31 is capable of transmitting and receiving data to and from another device via the Internet, using the wireless communication module 36, and is capable of transmitting and receiving data to and from another game apparatus of the same type, using the local communication module 37.

The acceleration sensor 39 is connected to the information processing section 31. The acceleration sensor 39 detects the magnitudes of the accelerations in the directions of straight lines (linear accelerations) along three axial (x, y, and z axes in the present embodiment) directions, respectively. The acceleration sensor 39 is provided, for example, within the lower housing 11. As shown in FIG. 1, the long side direction of the lower housing 11 is defined as an x-axis direction; the short side direction of the lower housing 11 is defined as a y-axis direction; and the direction perpendicular to the inner surface (main surface) of the lower housing 11 is defined as a z-axis direction. The acceleration sensor 39 thus detects the magnitudes of the linear accelerations produced in the respective axial directions. It should be noted that the acceleration sensor 39 is, for example, an electrostatic capacitance type acceleration sensor, but may be an acceleration sensor of another type. Further, the acceleration sensor 39 may be an acceleration sensor for detecting an acceleration in one axial direction, or accelerations in two axial directions. The information processing section 31 receives data indicating the accelerations detected by the acceleration sensor 39 (acceleration data), and calculates the orientation and the motion of the game apparatus 10.

The angular velocity sensor 40 is connected to the information processing section 31. The angular velocity sensor 40 detects the angular velocities generated about three axes (x, y, and z axes in the present embodiment) of the game apparatus 10, respectively, and outputs data indicating the detected angular velocities (angular velocity data) to the information processing section 31. The angular velocity sensor 40 is provided, for example, within the lower housing 11. The information processing section 31 receives the angular velocity data output from the angular velocity sensor 40, and calculates the orientation and the motion of the game apparatus 10.

The RTC 38 and the power circuit 41 are connected to the information processing section 31. The RTC 38 counts time, and outputs the counted time to the information processing section 31. The information processing section 31 calculates the current time (date) on the basis of the time counted by the RTC 38. The power circuit 41 controls the power from the power supply (the rechargeable battery accommodated in the lower housing 11, which is described above) of the game apparatus 10, and supplies power to each component of the game apparatus 10.

The I/F circuit 42 is connected to the information processing section 31. A microphone 43, a loudspeaker 44, and the touch panel 13 are connected to the I/F circuit 42. Specifically, the loudspeaker 44 is connected to the I/F circuit 42 through an amplifier not shown in the figures. The microphone 43 detects sound from the user, and outputs a sound signal to the I/F circuit 42. The amplifier amplifies the sound signal from the I/F circuit 42, and outputs sound from the loudspeaker 44. The I/F circuit 42 includes: a sound control circuit that controls the microphone 43 and the loudspeaker 44 (amplifier); and a touch panel control circuit that controls the touch panel 13. For example, the sound control circuit performs A/D conversion and D/A conversion on the sound signal, and converts the sound signal into sound data in a predetermined format. The touch panel control circuit generates touch position data in a predetermined format on the basis of a signal from the touch panel 13, and outputs the touch position data to the information processing section 31. The touch position data indicates the coordinates of the position (touch position) at which an input has been provided on the input surface of the touch panel 13. It should be noted that the touch panel control circuit reads a signal from the touch panel 13, and generates the touch position data, once in a predetermined time. The information processing section 31 acquires the touch position data, and thereby recognizes the touch position, at which the input has been provided on the touch panel 13.

An operation button 14 includes the operation buttons 14A through 14L described above, and is connected to the information processing section 31. Operation data is output from the operation button 14 to the information processing section 31, the operation data indicating the states of inputs provided to the respective operation buttons 14A through 14I (indicating whether or not the operation buttons 14A through 14I have been pressed). The information processing section 31 acquires the operation data from the operation button 14, and thereby performs processes in accordance with the inputs provided on the operation button 14.

The lower LCD 12 and the upper LCD 22 are connected to the information processing section 31. The lower LCD 12 and the upper LCD 22 each display an image in accordance with an instruction from the information processing section 31 (the GPU 312). In the present embodiment, the information processing section 31 causes an image for an input operation to be displayed on the lower LCD 12, and causes an image acquired from either one of the outer capturing section 23 and the inner capturing section 24 to be displayed on the upper LCD 22. That is, for example, the information processing section 31 causes a stereoscopic image (stereoscopically visible image) using a right-eye image and a left-eye image to be displayed on the upper LCD 22, the images captured by the inner capturing section 24, or causes a planar image using one of a right-eye image and a left-eye image to be displayed on the upper LCD 22, the images captured by the outer capturing section 23.

Specifically, the information processing section 31 is connected to an LCD controller (not shown) of the upper LCD 22, and causes the LCD controller to set the parallax barrier to on/off. When the parallax barrier is on in the upper LCD 22, a right-eye image and a left-eye image that are stored in the VRAM 313 of the information processing section 31 (that are captured by the outer capturing section 23) are output to the upper LCD 22. More specifically, the LCD controller repeatedly alternates the reading of pixel data of the right-eye image for one line in the vertical direction, and the reading of pixel data of the left-eye image for one line in the vertical direction, and thereby reads the right-eye image and the left-eye image from the VRAM 313. Thus, the right-eye image and the left-eye image are each divided into strip images, each of which has one line of pixels placed in the vertical direction, and an image including the divided left-eye strip images and the divided right-eye strip images alternately placed is displayed on the screen of the upper LCD 22. The user may view the images through the parallax barrier of the upper LCD 22, whereby the right-eye image is viewed with the user's right eye, and the left-eye image is viewed with the user's left eye. This causes the stereoscopically visible image to be displayed on the screen of the upper LCD 22.

The outer capturing section 23 and the inner capturing section 24 are connected to the information processing section 31. The outer capturing section 23 and the inner capturing section 24 each capture an image in accordance with an instruction from the information processing section 31, and output data of the captured image to the information processing section 31. In the present embodiment, the information processing section 31 gives either one of the outer capturing section 23 and the inner capturing section 24 an instruction to capture an image, and the capturing section that has received the instruction captures an image, and transmits data of the captured image to the information processing section 31. Specifically, the user selects the capturing section to be used, through an operation using the touch panel 13 and the operation button 14. The information processing section 31 (the CPU 311) detects that a capturing section has been selected, and the information processing section 31 gives an instruction to capture an image to the selected one of the outer capturing section 23 and the inner capturing section 24.

The 3D adjustment switch 25 is connected to the information processing section 31. The 3D adjustment switch 25 transmits an electrical signal corresponding to the position of the slider to the information processing section 31.

The 3D indicator 26 is connected to the information processing section 31. The information processing section 31 controls whether or not the 3D indicator 26 is to be lit on. When, for example, the upper LCD 22 is in the stereoscopic display mode, the information processing section 31 lights on the 3D indicator 26.

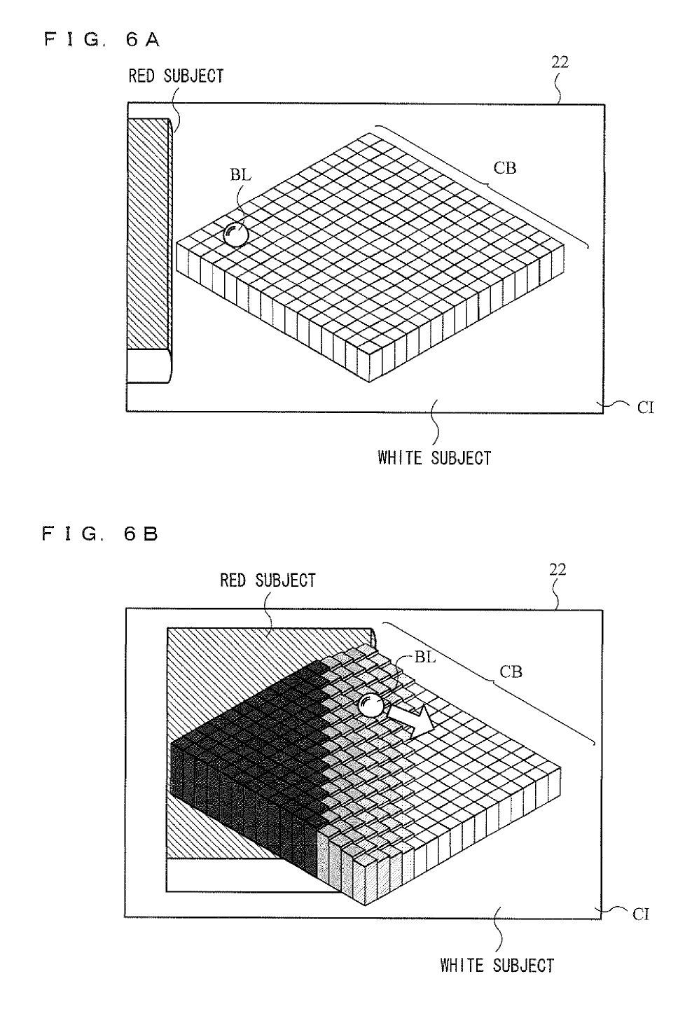

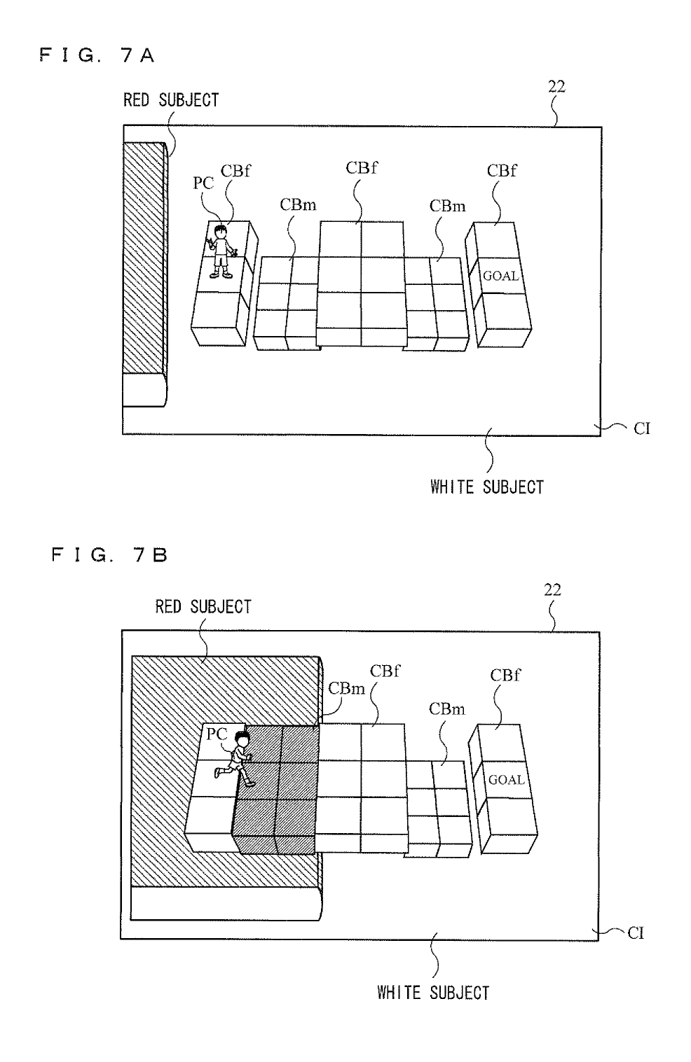

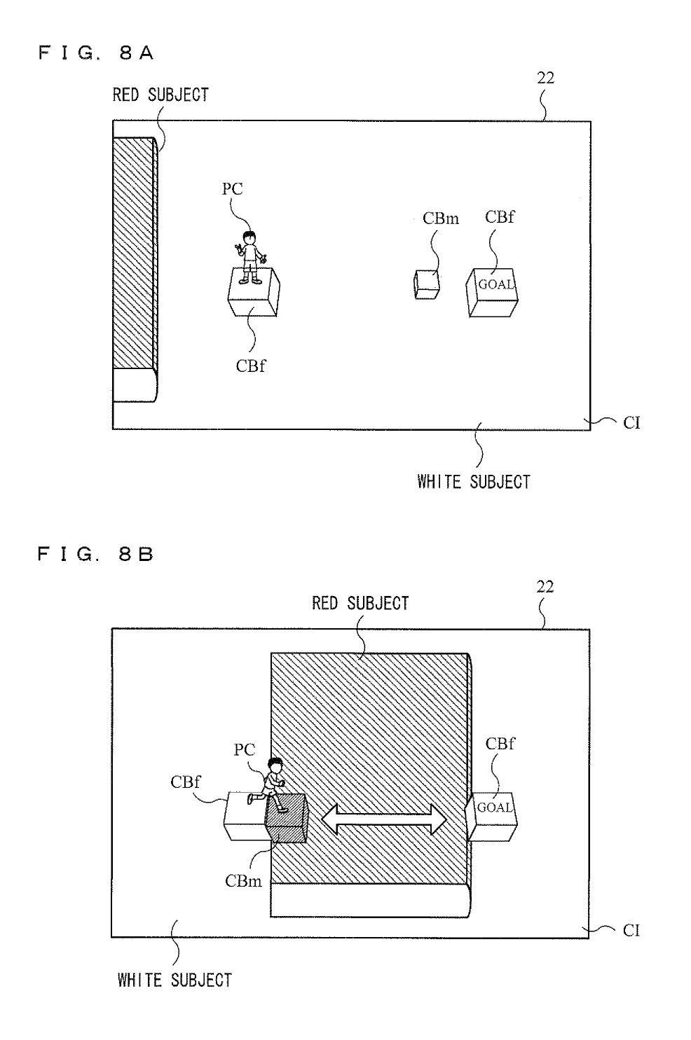

Next, before a description is given of specific display control processing operations performed by the display control program executed by the game apparatus 10, a description is given, with reference to FIGS. 6A through 8B, of examples of the forms of display performed on the upper LCD 22 by the display control processing operations. It should be noted that FIG. 6A is a diagram showing an example where in a first game example, display is performed on the upper LCD 22 such that a virtual world image is combined with a camera image CI. FIG. 6B is a diagram showing an example where in the first game example, display is performed on the upper LCD 22 such that a red subject included in the camera image CI and virtual objects are displayed so as to overlap each other. FIG. 7A is a diagram showing an example where in a second game example, display is performed on the upper LCD 22 such that a virtual world image is combined with the camera image CI. FIG. 7B is a diagram showing an example where in the second game example, display is performed on the upper LCD 22 such that a red subject included in the camera image CI and virtual objects are displayed so as to overlap each other. FIG. 8A is a diagram showing an example where in a third game example, display is performed on the upper LCD 22 such that a virtual world image is combined with the camera image CI. FIG. 8B is a diagram showing an example where in the third game example, display is performed on the upper LCD 22 such that a red subject included in the camera image CI and virtual objects are displayed so as to overlap each other. It should be noted that for ease of description, an example is where a planar image (a planar view image, as opposed to the stereoscopically visible image described above) of the real world on the basis of a camera image CI acquired from either one of the outer capturing section 23 and the inner capturing section 24 is displayed on the upper LCD 22.

In FIGS. 6A through 8B, in the first through third game examples, on the upper LCD 22, a camera image CI is displayed, which is a real world image captured by a real camera built into the game apparatus 10 (e.g., the outer capturing section 23). For example, in the first through third game examples, a real-time real world image (moving image) captured by the real camera built into the game apparatus 10 is displayed on the upper LCD 22.

In FIG. 6A, in the first game example, display is performed on the upper LCD 22 such that a virtual world image in which a plurality of cubes CB and a ball object BL are placed in a virtual world is combined with the camera image CI. Here, the plurality of cubes CB are placed so as to be integrated in a matrix manner into a single flat plate shape, and the upper surface of the flat plate shape is formed in the horizontal direction in the virtual world. Further, the ball object BL is placed on the upper surfaces of the plurality of cubes CB integrated in a matrix manner, and rolls along the upper surfaces. It should be noted that the example shown in FIG. 6A shows the case where in the camera image CI displayed on the upper LCD 22, a non-red subject (e.g., a white subject) is captured, and the subject and the plurality of cubes CB are displayed so as to overlap each other. It should be noted that in this example, in the camera image CI displayed on the upper LCD 22, a red subject is also captured, but the red subject and the plurality of cubes CB are displayed so as not to overlap each other. Further, when the ball object BL has moved onto a cube CB set as a goal at each game stage, the game is completed. If the ball object BL does not reach onto the goal cube CB within a predetermined time, the game is over.

In FIG. 6B, in the camera image CI displayed on the upper LCD 22, a red subject is captured, and the red subject and at least part of the plurality of cubes CB are displayed so as to overlap each other. In this case, the cubes CB overlapping the red subject deform in an extended manner such that the upper surfaces of the overlapping cubes CB rise relative to those of the other cubes CB, and change in color (e.g., change to red cubes CB). This produces differences in height between the upper surfaces and differences in color between the plurality of cubes CB integrated in a matrix manner, and results in the deformations of the plurality of cubes CB into a single plate shape on the upper surface of which differences in height are produced. When differences in height are produced on the upper surfaces of the plurality of cubes CB, the ball object BL placed on the upper surfaces meanwhile moves on the upper surfaces, rolling to the lower side (e.g., in the direction of an outlined arrow shown in FIG. 6B). That is, a player of the game apparatus 10 captures a red subject so as to overlap the plurality of cubes CB, and adjusts the capturing position of the red subject, and thereby can move the ball object BL placed on the plurality of cubes CB by rolling it. It should be noted that as an example, the amount of rise (the amount of extension) of each cube CB is determined on the basis of the saturation of the red pixel captured so as to overlap the cube CB. This will be described in detail later.

In FIG. 7A, in the second game example, display is performed on the upper LCD 22 such that a virtual world image in which fixed cubes CBf, movable cubes CBm, and a player character PC are placed in the virtual world is combined with the camera image CI. Here, all the fixed cubes CBf are placed at a reference height in the virtual world, and gaps are formed between some of the cubes CBf. Further, the movable cubes CBm are placed in the gaps formed between the fixed cubes CBf, and are placed at positions lower than the reference height in the virtual world. It should be noted that the example shown in FIG. 7A shows the case where in the camera image CI displayed on the upper LCD 22, a non-red subject (e.g., a white subject) is captured, and the subject and all the movable cubes CBm are displayed so as to overlap each other. It should be noted that in this example, in the camera image CI displayed on the upper LCD 22, a red subject is also captured, but the red subject and the movable cubes CBm are displayed so as not to overlap each other. The player character PC is capable of moving on the fixed cubes CBf or the movable cubes CBm, and moves in the virtual world in accordance with an operation of the player (e.g., an operation on the cross button 14A or the analog stick 15). For example, the player character PC moves on the fixed cubes CBf or the movable cubes CBm toward a goal provided in the virtual world. If, however, a gap is formed on a path to the goal, the player character PC is incapable of jumping across the gap. It should be noted that if the player character PC does not reach the goal within a predetermined time, or has fallen into a gap formed between the fixed cubes CBf, the game is over.

In FIG. 7B, in the camera image CI displayed on the upper LCD 22, a red subject is captured, and the red subject and at least part of the plurality of movable cubes CBm are displayed so as to overlap each other. In this case, the movable cubes CBm overlapping the red subject rise to near the reference height within the gap where the movable cubes CBm are placed, and change in color (e.g., change to red cubes CBm). Consequently, the gap formed between the fixed cubes CBf is filled with the movable cubes CBm. This enables the player character PC to move on the movable cubes CBm that have filled the gap, and thereby cross the gap. That is, when it is necessary to cause the player character PC to cross a gap formed between the fixed cubes CBf in order to lead the player character PC to the goal, the player of the game apparatus 10 may capture a red subject so as to overlap the movable cubes CBm placed in the gap, and thereby can clear an obstacle formed by the gap.

In FIG. 8A, in the third game example, display is performed on the upper LCD 22 such that a virtual world image in which fixed cubes CBf, a movable cube CBm, and a player character PC are placed in the virtual world is combined with the camera image CI. Here, all the fixed cubes CBf are placed at a reference height in the virtual world, and a gap is formed in part of the virtual world. Further, the movable cube CBm is placed in the gap formed between the fixed cubes CBf, and is placed at a position lower than the reference height in the virtual world. It should be noted that the example shown in FIG. 8A shows the case where in the camera image CI displayed on the upper LCD 22, a non-red subject (e.g., a white subject) is captured, and the subject and the movable cube CBm are displayed so as to overlap each other. It should be noted that in this example, in the camera image CI displayed on the upper LCD 22, a red subject is also captured, but the red subject and the movable cube CBm are displayed so as not to overlap each other. The player character PC is capable of moving on the fixed cubes CBf or the movable cube CBm, and moves in the virtual world in accordance with an operation of the player (e.g., an operation on the cross button 14A or the analog stick 15). For example, the player character PC moves on the fixed cubes CBf or the movable cube CBm toward a goal provided in the virtual world. However, as in the second game example, if a gap is formed on a path to the goal, the player character PC is incapable of jumping across the gap. It should be noted that as in the second game example, if the player character PC does not reach the goal within a predetermined time, or has fallen into a gap formed between the fixed cubes CBf, the game is over.

In FIG. 8B, in the camera image CI displayed on the upper LCD 22, a red subject is captured, and the red subject and the movable cube CBm are displayed so as to overlap each other. In this case, the movable cube CBm overlapping the red subject rises to near the reference height within the gap where the movable cube CBm is placed, goes back and forth within the gap between the fixed cubes CBf placed on the left and right of the gap (e.g., goes back and forth in the directions of an outlined arrow shown in FIG. 8B), and changes in color (e.g., changes to a red cube CBm). Consequently, the movable cube CBm goes back and forth within the gap formed between the fixed cubes CBf. This enables the player character PC to move onto the movable cube CBm that goes back and forth within the gap, and thereby cross the gap, riding on the movable cube CBm. That is, when it is necessary to cause the player character PC to cross a gap formed between the fixed cubes CBf in order to lead the player character PC to the goal, the player of the game apparatus 10 may capture a red subject so as to overlap the movable cube CBm placed in the gap, and thereby can clear an obstacle formed by the gap. It should be noted that the velocity of the going back and forth of the movable cube CBm may vary depending on the hue, the saturation, the brightness, or the like of the red pixel captured so as to overlap the movable cube CBm, or may be fixed to a velocity set in advance.

As described above, when a subject of a specific color (red in the above examples) is included in a captured image of the real world that is being captured by the user themselves, the subject and a specific virtual object (the cubes CB or the movable cubes CBm) may be caused to overlap each other, whereby display is performed on the upper LCD 22 such that at least one of the shape, the position, and the display form of the virtual object changes. For example, virtual objects (the cubes CB, the fixed cubes CBf, the movable cubes CBm, the ball object BL, the player character PC, and the like) are placed in a virtual space, and an image of the virtual space, in which the virtual objects are viewed from a virtual camera (e.g., a computer graphics image; hereinafter referred to as a “virtual world image”), is combined with the real world image obtained from the camera image CI. Thus, the virtual objects are displayed on the upper LCD 22 as if placed in real space.

Here, to detect a specific color from the camera image, it is possible to use color information of each pixel of the camera image. The color information of each pixel may possibly include, for example, the RGB values, the value representing the hue, the value representing the saturation, and the value representing the brightness. In the present embodiment, any of these values may be used.

As a first example, the specific color is detected by combining the above values. Specifically, when the value representing the saturation and the value representing the brightness are equal to or greater than predetermined thresholds, respectively, and the value representing the hue is included within a predetermined range indicating the specific color, it is determined that the pixel represents the specific color. Such a determination of the specific color by combining a plurality of items of the color information makes it possible to bring the determination result close to the color recognition normally performed by the user to make a distinction, while preventing erroneous color determinations.

As a second example, the specific color is detected using any one of the above values. As an example, it is possible to distinguish in the camera image a pixel having a brightness equal to or greater than a predetermined threshold, using only the value representing the brightness. In this case, when a subject having a brightness equal to or greater than the predetermined threshold overlaps a specific virtual object in the camera image, it is possible to perform display control processing where at least one of the shape, the position, and the display form of the virtual object is changed. As another example, a pixel satisfying predetermined conditions may be distinguished in the camera image as a pixel having the specific color, using only the RGB values, only the value representing the hue, or only the value representing the saturation.

It should be noted that the specific color on the basis of which at least one of the shape, the position, and the display form of the virtual object is to be changed may vary depending on the virtual object placed in the virtual world. Alternatively, to indicate to the user the specific color on the basis of which at least one of the shape, the position, and the display form of the virtual object is to be changed, the virtual object may be displayed in colors such as the specific color and the complementary color of the specific color. Further, the amount of deformation by which the virtual object deforms, the amount of movement by which the virtual object changes in position, the amount of change by which the virtual object changes in display form, and the like may be varied depending on the color information of the pixel overlapping the virtual object. Furthermore, the virtual object displayed on the upper LCD 22 may be displayed on the upper LCD 22 without being combined with the camera image. In this case, the camera image captured by the real camera built into the game apparatus 10 is not displayed on the upper LCD 22, and when a specific virtual object is placed at the position overlapping a specific-colored subject captured on the assumption that the camera image and the virtual world image are combined together, display is performed on the upper LCD 22 such that at least one of the shape, the position, and the display form of the overlapping specific virtual object is changed. That is, only the virtual space viewed from the virtual camera is displayed on the upper LCD 22. In this case, however, the camera image captured by the real camera may be displayed on the lower LCD 12.

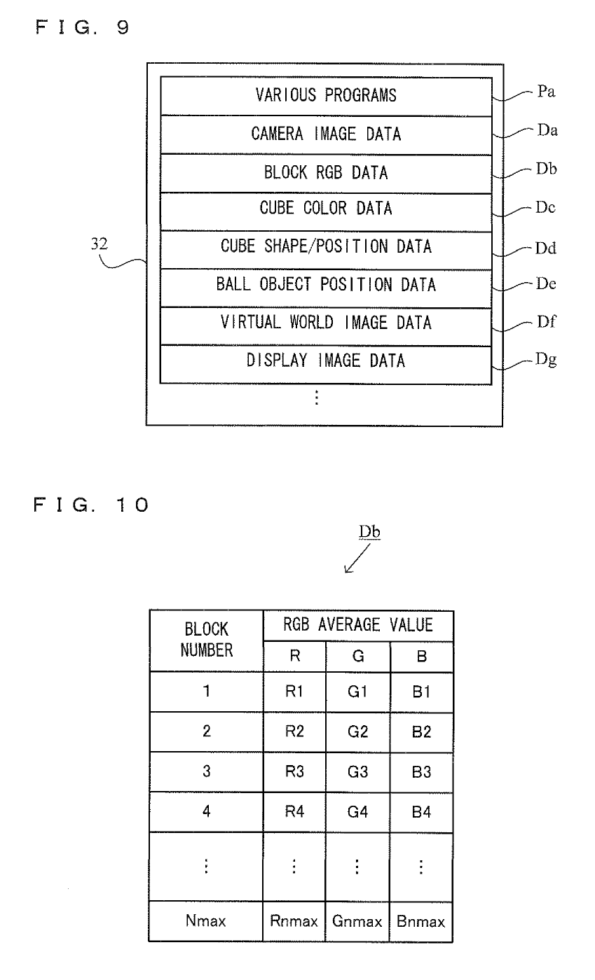

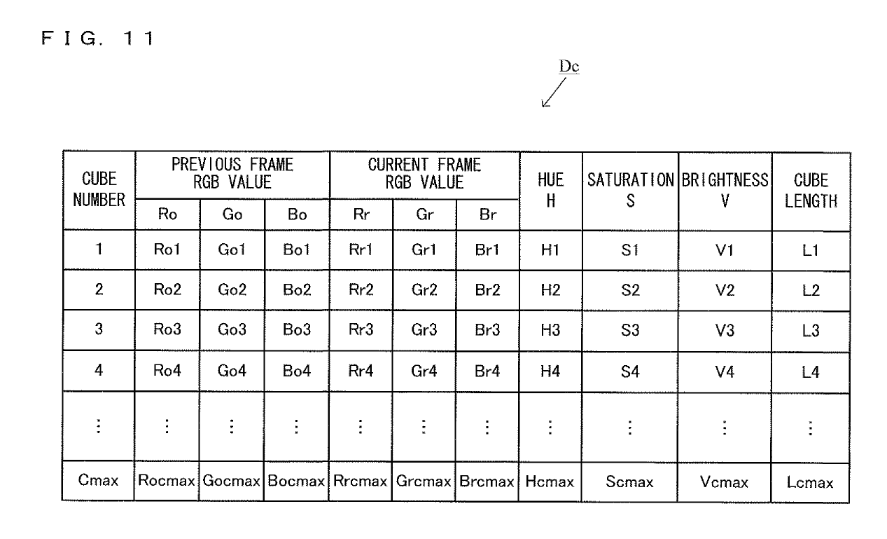

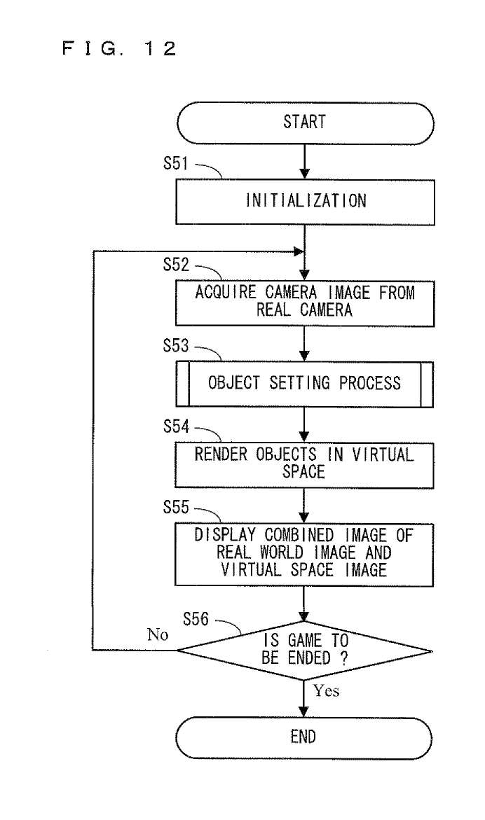

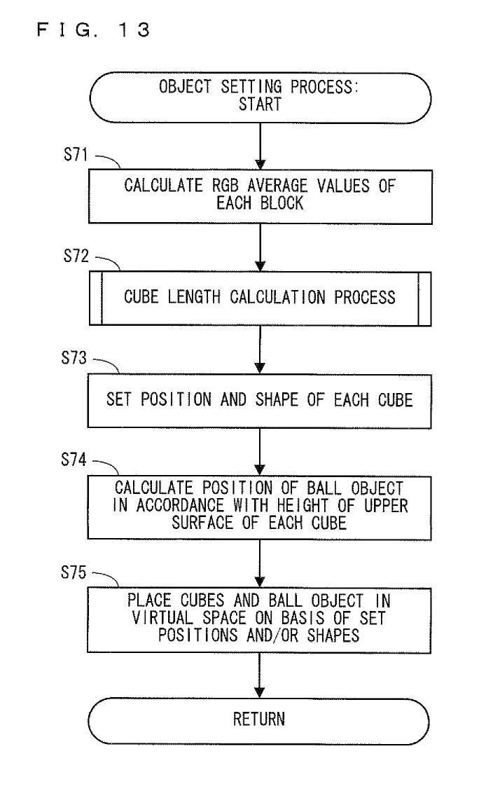

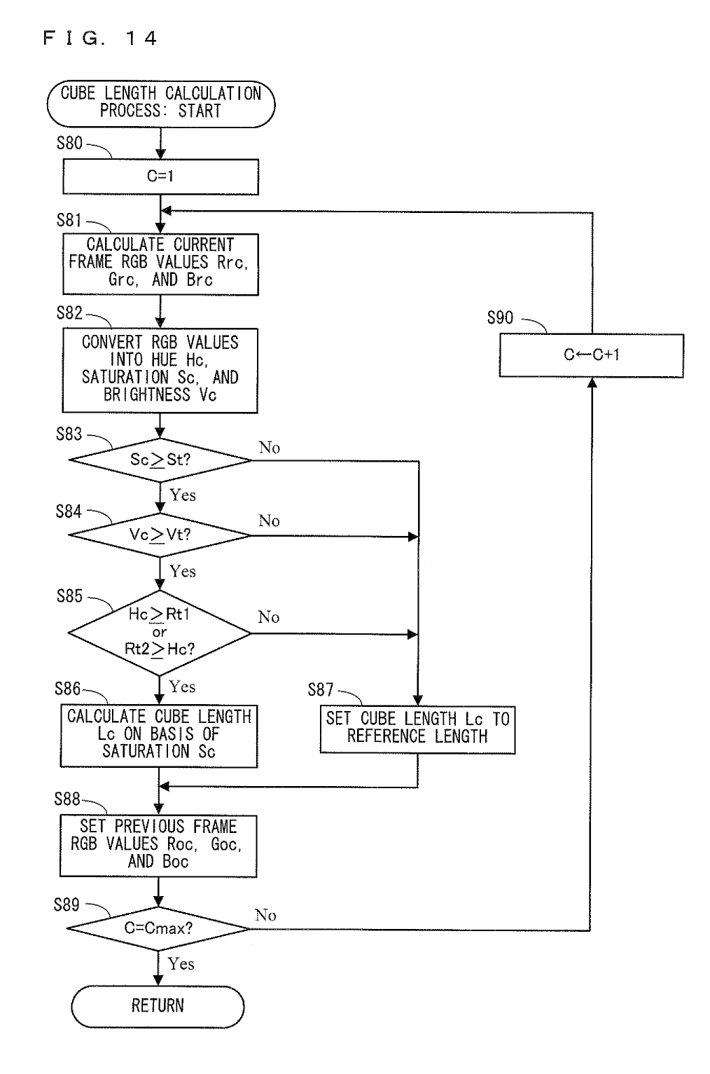

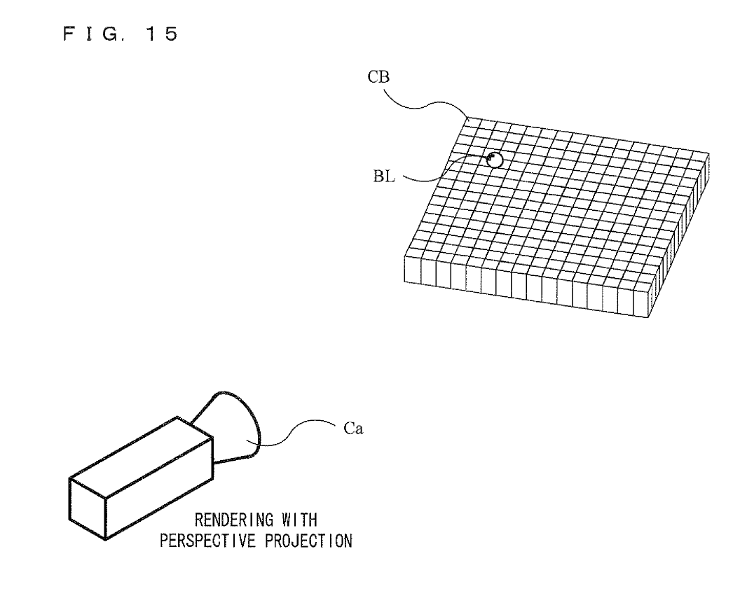

Next, with reference to FIGS. 9 through 14, a description is given of the specific processing operations performed by the display control program executed by the game apparatus 10. It should be noted that FIG. 9 is a diagram showing an example of various data stored in the main memory 32 in accordance with the execution of the display control program. FIG. 10 is a diagram showing an example of block RGB data Db of FIG. 9. FIG. 11 is a diagram showing an example of cube color data Dc of FIG. 9. FIG. 12 is a flow chart showing an example of the operation of display control processing performed by the game apparatus 10 in accordance with the execution of the display control program. FIG. 13 is a subroutine flow chart showing an example of a detailed operation of an object setting process performed in step 53 of FIG. 12. FIG. 14 is a subroutine flow chart showing an example of a detailed operation of a cube length calculation process performed in step 72 of FIG. 13. It should be noted that the first game example described above is used in the following descriptions of the processing operations. It should be noted that programs for performing these processes are included in a memory built into the game apparatus 10 (e.g., the data storage internal memory 35), or included in the external memory 45 or the data storage external memory 46, and the programs are: loaded from the built-in memory, or loaded from the external memory 45 through the external memory I/F 33 or from the data storage external memory 46 through the data storage external memory I/F 34, into the main memory 32 when the game apparatus 10 is turned on; and executed by the CPU 311.

Referring to FIG. 9, the main memory 32 stores the programs loaded from the built-in memory, the external memory 45, or the data storage external memory 46, and temporary data generated in the display control processing. Referring to FIG. 9, the following are stored in a data storage area of the main memory 32: camera image data Da; block RGB data Db; cube color data Dc; cube shape/position data Dd; ball object position data De; virtual world image data Df; display image data Dg; and the like. Further, in a program storage area of the main memory 32, a group of various programs Pa are stored that configure the display control program.

The camera image data Da indicates a camera image captured by either one of the outer capturing section 23 and the inner capturing section 24. In the following descriptions of processing, in the step of acquiring a camera image, the camera image data Da is updated using a camera image captured by either one of the outer capturing section 23 and the inner capturing section 24. It should be noted that the cycle of updating the camera image data Da using the camera image captured by the outer capturing section 23 or the inner capturing section 24 may be the same as the unit of time in which the game apparatus 10 performs processing (e.g., 1/60 seconds), or may be shorter than this unit of time. When the cycle of updating the camera image data Da is shorter than the cycle of the game apparatus 10 performing processing, the camera image data Da may be updated as necessary, independently of the processing described later. In this case, in the step described later of acquiring a camera image, the process may be performed invariably using the most recent camera image indicated by the camera image data Da.

The block RGB data Db indicates the RGB average values calculated from the camera image on a block-by-block basis. With reference to FIG. 10, an example of the block RGB data Db is described below.

Referring to FIG. 10, as an example, the camera image captured by either one of the outer capturing section 23 and the inner capturing section 24 (hereinafter referred to simply as a “camera image”) is divided into blocks each having a predetermined size (e.g., a block of 8×8 pixels), and the ROB average values are calculated for each block. Specifically, the camera image is divided into Nmax blocks, and block numbers 1 through Nmax are assigned to the respective blocks. Then, in the block RUB data Db, the RGB average values are described for each block. For example, in the block of the block number 1, it is indicated that the RGB average values are R1, G1, and B1. Further, in the block of the block number 2, it is indicated that the RGB average values are R2, G2, and B2.

Referring back to FIG. 9, the cube color data Dc indicates the color information and the cube length of each cube CB placed in the virtual space when displayed. With reference to FIG. 11, an example of the cube color data De is described below.

Referring to FIG. 11, cube numbers 1 through Cmax are assigned to the respective cubes CB placed in the virtual space when displayed. Then, in the cube color data De, the following are described for each cube CB: the previous frame RGB values; the current frame RGB values; the value representing a hue H; the value representing a saturation S; the value representing a brightness V; and the value indicating the set cube length. For example, in the cube CB of the cube number 1, it is indicated that: the previous frame RGB values are Ro1, Go1, and Bo1; the current frame RGB values are Rr1, Gr1, and Br1; the value representing the hue H is H1; the value representing the saturation S is S1; the value representing the brightness V is V1; and the cube length of the cube CB is L1. Further, in the cube CB of the cube number 2, it is indicated that: the previous frame RGB values are Ro2, Go2, and Bo2; the current frame RGB values are Rr2, Gr2, and Br2; and the value representing the hue H is H2; the value representing the saturation S is S2; the value representing the brightness V is V2; and the cube length of the cube CB is L2.

Referring back to FIG. 9, the cube shape/position data Dd indicates the shape, the placement position, the placement direction, and the like of each cube CB in the virtual space when display is performed such that the cube CB is combined with the camera image. The ball object position data De indicates the placement position and the like of the ball object BL in the virtual space when display is performed such that the ball object BL is combined with the camera image.

The virtual world image data Df indicates a virtual world image obtained by rendering with a perspective projection the virtual space where the ball object BL and the plurality of cubes CB are placed.

The display image data Dg indicates a display image to be displayed on the upper LCD 22. For example, the display image to be displayed on the upper LCD 22 is generated by superimposing the virtual world image on the camera image such that the virtual world image is given preference.

Next, with reference to FIG. 12, a description is given of the operation of the information processing section 31. First, when the power (the power button 14F) of the game apparatus 10 is turned on, the CPU 311 executes a boot program (not shown). This causes the programs stored in the built-in memory, the external memory 45, or the data storage external memory 46, to be loaded into the main memory 32. In accordance with the execution of the loaded programs by the information processing section 31 (the CPU 311), the steps (abbreviated as “S” in FIGS. 12 through 14) shown in FIG. 12 are performed. It should be noted that in FIGS. 12 through 14, processes not directly related to the present invention are not described.

Referring to FIG. 12, the information processing section 31 performs the initialization of the display control processing (step 51), and proceeds to the subsequent step. For example, the information processing section 31 sets in the virtual space the virtual camera for generating a virtual world image, and sets the coordinate axes (e.g., X, Y, and Z axes) of the virtual space where the virtual camera is placed. Then, the information processing section 31 places the plurality of cubes CB and the ball object BL at initial positions, respectively, in the virtual space, and sets the shape of each cube CB (specifically, a cube length L) to an initial shape (an initial length Li). For example, the information processing section 31 sets the shapes of the plurality of cubes CB, and places the plurality of cubes CB such that the plurality of cubes CB are integrated in a matrix manner into a single flat plate shape having a predetermined thickness, and that the upper surface of the flat plate shape is formed in the horizontal direction in the virtual space (e.g., a direction parallel to the XZ plane of the virtual space), to thereby update the cube color data Dc and the cube shape/position data Dd using the initial position and the shape of each cube CB. Further, the information processing section 31 places the ball object BL at the initial position on the upper surfaces of the plurality of cubes CB integrated in a matrix manner, to thereby update the ball object position data De using the initial position of the ball object BL. Furthermore, the information processing section 31 initializes other parameters to be used in the subsequent display control processing.

Next, the information processing section 31 acquires a camera image from the real camera of the game apparatus 10 (step 52), and proceeds to the subsequent step. For example, the information processing section 31 updates the camera image data Da using a camera image captured by the currently selected capturing section (the outer capturing section 23 or the inner capturing section 24).

Next, the information processing section 31 performs an object setting process (step 53), and proceeds to the subsequent step. With reference to FIG. 13, an example of the object setting process is described below.

Referring to FIG. 13, the information processing section 31 calculates the RGB average values of each block (step 71), and proceeds to the subsequent step. As described above, the camera image is divided into Nmax blocks. For example, the information processing section 31 extracts the RGB values of pixels corresponding to the block of the block number N (e.g., 8×8 pixels) from the camera image indicated by the camera image data Da, and calculates the average values of the respective RGB values. Then, the information processing section 31 updates the block RGB data Db corresponding to the RGB average values of the block number N, using the calculated RGB average values. As described above, the information processing section 31 calculates the RGB average values of all the Nmax blocks into which the camera image indicated by the camera image data Da is divided, to thereby update the block RGB data Db using the calculated RGB average values.

Next, the information processing section 31 performs a cube length calculation process (step 72), and proceeds to the subsequent step. With reference to FIG. 14, an example of the cube length calculation process is described below.

Referring to FIG. 14, the information processing section 31 sets a temporary variable C used in this subroutine to 1 (step 80), and proceeds to the subsequent step.

Next, the information processing section 31 calculates the current frame ROB values of the cube CB of the cube number C (step 81), and proceeds to the subsequent step. For example, the information processing section 31 extracts a block that overlaps the cube CB of the cube number C when the virtual world image is combined with the camera image (e.g., a block that overlaps a point at the center of the bottom surface of the cube CB of the cube number C), and, with reference to the block RGB data Db, acquires the calculated RGB average values (Rn, On, Bn) of the block. Then, the information processing section 31 calculates the current frame RGB values (Rrc, Grc, Brc) of the cube CB of the cube number C, using the following formulas.

Rrc=Roc+(Rn−Roc)/4

Grc=Goc+(Gn−Goc)/4

Brc=Boc+(Bn−Boc)/4

Here, Roc, Goc, and Boc are the ROB values of the cube CB of the cube number C calculated in the previous process (in the process in the previous frame) (previous frame RGB values), and are acquired with reference to the cube color data De corresponding to the previous frame RGB values of the cube number C. Then, the information processing section 31 updates the cube color data De corresponding to the current frame RGB values of the cube number C, using the calculated current frame RGB values. Such calculations are perforated in order to prevent the display of an image in which the lengths of the cubes CB change rapidly. Further, rapid changes in the lengths of the cubes CB make the game very difficult. The calculations are performed also in order to prevent this.

Next, the information processing section 31 converts the current frame RGB values calculated in step 81 described above into a hue Hc, a saturation Sc, and a brightness Vc (step 82), and proceeds to the subsequent step. Then, the information processing section 31 updates the cube color data Dc corresponding to the hue H, the saturation S, and the brightness V of the cube number C, using the values of the hue Hc, the saturation Sc, and the brightness Vc that have been obtained from the conversions.

Here, the conversions of the current frame ROB values into the hue Hc, the saturation Sc, and the brightness Vc may be performed using a commonly used technique. For example, if each component of the current frame RGB values (i.e., Rrc, Ore, and Brc) is represented as from 0.0 to 1.0; “max” is a maximum value of each component; and “min” is a minimum value of each component, the conversions into the hue Hc are performed by the following formulas.

When, among all the components, the value of Rrc is max:

Hc=60×(Grc−Brc)/(max−min)

When, among all the components, the value of Grc is max:

Hc=60×(Brc−Rrc)/(max−min)+120

When, among all the components, the value of Brc is max:

Hc=60×(Rrc−Grc)/(max−min)+240

It should be noted that when Hc is a negative value as a result of the conversions using the above formulas, 360 is further added to Hc to obtain the hue Hc. Further, the conversions into the saturation Sc and the brightness Vc are performed by the following formulas.

Sc=(max−min)/max

Vc=max

When the hue Hc, the saturation Sc, and the brightness Vc are calculated using the above conversion formulas, the hue Hc is obtained in the range of from 0.0 to 360.0; the saturation Sc is obtained in the range of from 0.0 to 1.0; and the brightness Vc is obtained in the range of from 0.0 to 1.0.

Next, the information processing section 31 determines whether or not the saturation Sc calculated in step 82 described above is equal to or greater than a threshold St (e.g., St=0.125) (step 83). Then, when the saturation Sc is equal to or greater than the threshold St, the information processing section 31 proceeds to the subsequent step 84. On the other hand, when the saturation Sc is less than the threshold St, the information processing section 31 proceeds to the subsequent step 87.

In step 84, the information processing section 31 determines whether or not the brightness Vc calculated in step 82 described above is equal to or greater than a threshold Vt (e.g., Vt=0.37). Then, when the brightness Vc is equal to or greater than the threshold Vt, the information processing section 31 proceeds to the subsequent step 85. On the other hand, when the brightness Vc is less than the threshold Vt, the information processing section 31 proceeds to the subsequent step 87.

In step 85, the information processing section 31 determines whether or not the hue Hc calculated in step 82 described above is equal to or greater than a threshold Rt1 (e.g., Rt1=348.75) or equal to or less than a threshold Rt2 (e.g., Rt2=11.25) (i.e., whether or not the hue Hc is included in the range of red). Then, when the determination of step 85 described above is positive, the information processing section 31 proceeds to the subsequent step 86. On the other hand, when the determination of step 85 described above is negative, the information processing section 31 proceeds to the subsequent step 87.

In step 86, the information processing section 31 calculates a cube length Lc of the cube CB of the cube number C on the basis of the saturation Sc calculated in step 82 described above, and proceeds to the subsequent step 88. As an example, the information processing section 31 calculates the cube length Lc so as to be directly proportional to the saturation Sc, to thereby update the cube color data Dc corresponding to the cube length of the cube number C, using the calculated cube length Lc.

Meanwhile, in step 87, the information processing section 31 sets the cube length Lc of the cube CB of the cube number C to a reference length (e.g., the cube length Li at the initialization), and proceeds to the subsequent step 88. For example, the information processing section 31 updates the cube color data Dc corresponding to the cube length of the cube number C, using the cube length Lc set to the reference height.

In step 88, the information processing section 31 updates the previous frame RGB values of the cube number C using the current frame RGB values of the cube number C, and proceeds to the subsequent step. For example, the information processing section 31 updates the previous frame RGB values (Roc, Goc, Boc) of the cube number C in the cube color data Dc using the current frame RGB values (Rrc, Grc, Brc) of the cube number C indicated by the cube color data De.

Next, the information processing section 31 determines whether or not the currently set temporary variable C is Cmax (step 89). Then, when the temporary variable C is Cmax, the information processing section 31 ends the process of this subroutine. On the other hand, when the temporary variable C has not reached Cmax, the information processing section 31 adds 1 to the currently set temporary variable C to thereby set a new temporary variable C (step 90), returns to step 81 described above, and repeats the same process.

Referring back to FIG. 13, after the cube length calculation process in step 72 described above, the information processing section 31 sets the position and the shape of each cube CB in the virtual space to thereby update the cube shape/position data Dd (step 73), and proceeds to the subsequent step. As an example, the information processing section 31 sets the shapes of the upper surfaces of all the cubes CB to be the same as one another and the shapes of the lower surfaces of all the cubes CB to be the same as one another in the virtual space, and sets the shapes of the side surfaces of each cube CB such that the vertical lengths of the four side surfaces of the cube CB are the set cube length L of the cube CB. Then, the information processing section 31 sets the position of each cube CB such that all the cubes CB are integrated in a matrix manner into a flat plate shape in the virtual space, and the lower surfaces of all the cubes CB (the lower surface of the flat plate shape) are arranged on the same horizontal plane in the virtual space (e.g., arranged on the same XZ plane in the virtual space). That is, on the upper surface of the flat plate shape formed by integrating all the cubes CB in a matrix manner, differences in height are produced in accordance with the cube length L of each cube CB.

Next, the information processing section 31 sets the position of the ball object BL in the virtual space to thereby update the ball object position data De (step 74), and proceeds to the subsequent step. For example, in accordance with the heights of the upper surface of the flat plate shape formed by integrating all the cubes CB, the information processing section 31 calculates the position of the ball object BL to be placed on the upper surface. Specifically, with reference to the height of the upper surface (the cube length L) of cubes CB (peripheral cubes CB) placed in the periphery of a cube CB (placement cube CB) on the upper surface of which the ball object BL is placed, the information processing section 31 moves the ball object BL, on the basis of the laws of physics, to a peripheral cube CB whose upper surface is lower than that of the placement cube CB. It should be noted that the information processing section 31 moves the ball object BL on the basis of the laws of physics set in advance in the virtual space, and therefore, in principle, moves the ball object BL to a peripheral cube CB having a lower upper surface. Alternatively, the ball object BL may also move to another peripheral cube CB on the basis of the moving velocity and the moving direction of the ball object BL until the most recent time. As an example, even when the upper surface of a peripheral cube CB is the same in height as that of the placement cube CB, if the moving direction of the ball object BL until the most recent time is the direction of the peripheral cube CB, the ball object BL is moved to the peripheral cube CB. As another example, even when the upper surface of a peripheral cube CB is higher than that of the placement cube CB, if the moving direction of the ball object BL until the most recent time is the direction of the peripheral cube CB, and the ball object BL is moving at a moving velocity that causes the ball object BL to move beyond the difference in height with the peripheral cube CB even on the basis of the laws of physics, the ball object BL is moved to the peripheral cube CB.

Next, the information processing section 31 places the cubes CB and the ball object BL in the virtual space on the basis of the set positions and/or shapes (step 75), and ends the process of this subroutine. For example, with reference to the cube shape/position data Dd and the ball object position data De, the information processing section 31 places the plurality of cubes CB and the ball object BL on the basis of the positions and/or shape set in the virtual space. As an example, in the present embodiment, as shown in FIG. 15, the information processing section 31 generates, as a virtual world image, an image obtained by rendering the plurality of cubes CB and the ball object BL with a perspective projection from a virtual camera Ca. Here, in the processing described above, the positions of the plurality of cubes CB are set such that the plurality of cubes CB are integrated in a matrix manner into a flat plate shape, and the lower surfaces of all the cubes CB are arranged on the same horizontal plane in the virtual space. The position of the ball object BL is set such that the ball object BL is placed on the upper surface of any of the cubes CB. Thus, the plurality of cubes CB and the ball object BL are placed in the virtual space such that the plurality of cubes CB are integrated into a flat plate shape, and the ball object BL is mounted on the upper surface of the flat plate shape.

Referring back to FIG. 12, after the object setting process in step 53 described above, the information processing section 31 performs a process of rendering the virtual space (step 54), and proceeds to the subsequent step. For example, the information processing section 31 updates the virtual world image data Df using an image obtained by rendering the virtual space where the plurality of cubes CB and the ball object BL are placed. For example, as shown in FIG. 15, in the virtual space, the plurality of cubes CB and the ball object BL are placed in accordance with the shapes, the positions, and the directions indicated by the cube shape/position data Dd and the ball object position data De. Further, in the virtual space, the virtual camera Ca for rendering the virtual space is placed at a predetermined position and in a predetermined direction. Then, the information processing section 31 generates a virtual world image by rendering with a perspective projection from the virtual camera Ca the plurality of cubes CB and the ball object BL that are placed in the virtual space, to thereby update the virtual world image data Df using the generated virtual world image.

Next, the information processing section 31 generates a display image obtained by combining the camera image with the virtual world image, displays the display image on the upper LCD 22 (step 55), and proceeds to the subsequent step. For example, the information processing section 31 acquires the camera image indicated by the camera image data Da and the virtual world image indicated by the virtual world image data Df, and generates a display image by superimposing the virtual world image on the camera image such that the virtual world image is given preference, to thereby update the display image data Dg using the display image. Further, the CPU 311 of the information processing section 31 stores the display image indicated by the display image data Dg in the VRAM 313. Then, the GPU 312 of the information processing section 31 may output the display image drawn in the VRAM 313 to the upper LCD 22, whereby the display image is displayed on the upper LCD 22. It should be noted that when a virtual world image is not stored in the virtual world image data Df, the information processing section 31 may use the camera image indicated by the camera image data Da as it is as the display image.

Next, the information processing section 31 determines whether or not the game is to be ended (step 56). Conditions for ending the game may be, for example: that particular conditions have been satisfied so that the game is over; or that the user has performed an operation for ending the game. When the game is not to be ended, the information processing section 31 proceeds to step 52 described above, and repeats the same process. On the other hand, when the game is to be ended, the information processing section 31 ends the process of the flow chart.

As described above, in the display control processing according to the above embodiment, when a specific-colored subject is included in the camera image obtained from the real camera, display is performed such that the cubes CB displayed so as to overlap the specific-colored subject extend, and the cubes CB also change in color. This makes it possible to display a new image in which a virtual object deforms and changes in color in accordance with a subject overlapping the virtual object. Further, in another game example, when a specific-colored subject is included in the camera image obtained from the real camera, if the movable cubes CBm are displayed so as to overlap the specific-colored subject, display is performed such that the movable cubes CBm move, and the movable cubes CBm also change in color. This also makes it possible to display a new image in which a virtual object moves in accordance with a subject overlapping the virtual object.

It should be noted that in the first game example described above, as an example, when a specific-colored subject is included in the camera image obtained from the real camera, the cubes CB displayed so as to overlap the specific-colored subject extend. The deformations of the cubes CB cause the positions of the upper surfaces of the cubes CB to rise, and move the ball object BL on the basis of the differences in height between the upper surfaces. Alternatively, the cubes CB may be moved upward by imparting other changes to the cubes CB. For example, when a specific-colored subject is included in the camera image obtained from the real camera, the cubes CB displayed so as to overlap the specific-colored subject may be moved upward, or the cubes CB displayed so as to overlap the specific-colored subject may be enlarged in size. Also in this case, it is possible to cause the positions of the upper surfaces of the cubes CB to rise, and move the ball object BL on the basis of the differences in height between the upper surfaces. For example, it is possible to achieve a similar game by, in accordance with the saturation of the overlapping specific color, setting the rise distance by which each cube CB rises and the enlargement ratio by which each cube CB is enlarged in size. Further, in the first game example, when a specific-colored subject is included in the camera image obtained from the real camera, the cubes CB displayed so as to overlap the specific-colored subject may be caused to contract, may be moved downward, or may be reduced in size. The deformations and the movements of the cubes CB cause the positions of the upper surfaces of the cubes CB to fall. This makes it possible to move the ball object BL on the basis of the differences in height between the upper surfaces. Thus, in the first game example described above, on the basis of the differences in height between the upper surfaces of the cubes CB produced by the extensions or contractions, the rises or falls, and the enlargements or reductions of the cubes CB displayed so as to overlap the specific-colored subject, it is possible to move the ball object BL.

In addition, in the above descriptions, as an example, “red” is the specific color of the subject in the camera image, on the basis of which at least one of the shape, the position, and the display form of the virtual object is to change. Alternatively, other colors and other attributes may serve as specific colors on the basis of which the change is to occur. For example, other hues, such as green, blue, orange, yellow, purple, and pink, may be set as specific colors on the basis of which the change is to occur. Achromatic colors, such as black, gray, and white, may be set as specific colors on the basis of which the change is to occur. Alternatively, a color brighter or a color darker than a predetermined threshold (a color having a relatively high brightness or a color having a relatively low brightness), or a color closer to or a color further from a pure color than a predetermined threshold (a color having a relatively high saturation or a color having a relatively low saturation) may be set as a specific color on the basis of which the change is to occur. It is needless to say that the use of at least one of the items of the color information, namely, the RGB values, the hue, the saturation, and the brightness, enables an object setting process similar to the above.

In addition, an image obtained by inverting the lightness and darkness or the colors of a subject (a negative image) in the camera image captured by the real camera may be displayed on the upper LCD 22. In this case, the information processing section 31 may invert the RGB values of the entire camera image stored in the camera image data Da, whereby it is possible to generate the negative image. Specifically, when the RGB values of the camera image are each indicated as a value of from 0 to 255, the values obtained by subtracting each of the RGB values from 255 are obtained as the RGB values (e.g., in the case of the ROB values (150, 120, 60), the RGB values (105, 135, 195) are obtained). This makes it possible to invert the RGB values as described above. In this case, to change at least one of the shape, the position, and the display form of the virtual object, the player of the game apparatus 10 needs to overlap the virtual object on the subject captured in the complementary color (e.g., blue-green when the specific color is red) of the specific color in the negative image displayed on the upper LCD 22, and requires new thought to advance the game. It should be noted that the fact that the ball object BL or the player character PC has reached a specific cube CB may trigger a change from the camera image displayed on the upper LCD 22 to the negative image.

In addition, in the above descriptions, as an example, the camera image is divided into blocks each having a predetermined size, the RGB average values of each block are calculated, and the current frame ROB values of each cube CB is calculated using the calculated RGB average values. Alternatively, the RGB average values may be calculated in another unit. For example, the current frame RGB values of each cube CB may be calculated directly using the RGB values of each pixel in the camera image.

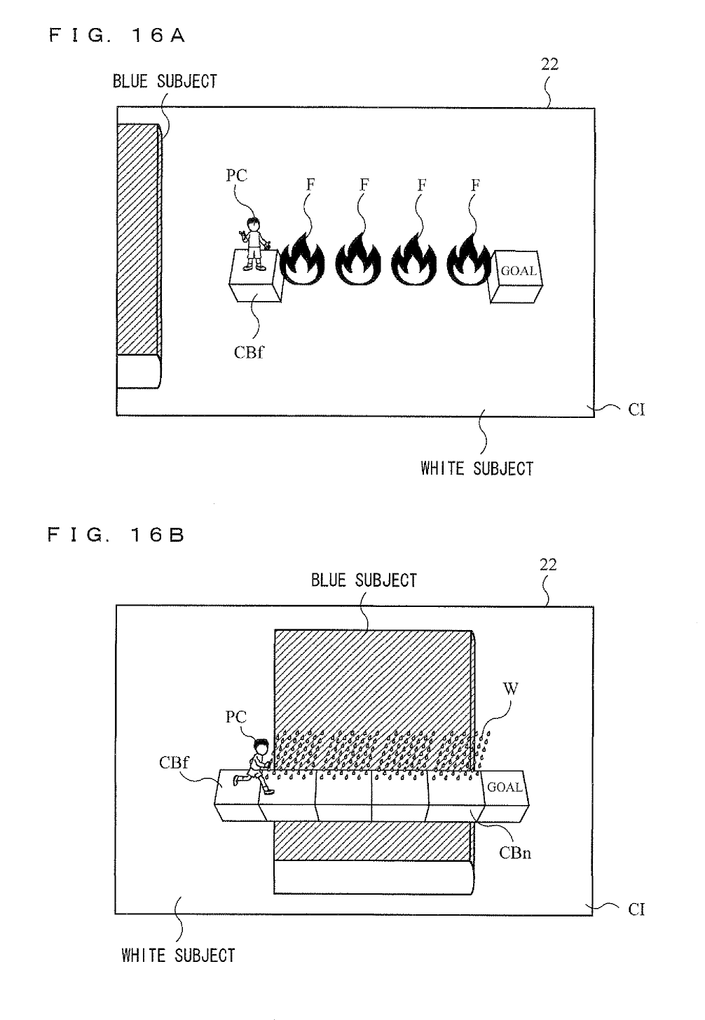

In addition, in the game examples described above, as an example, the shape and the display form of a virtual object overlapping a subject of a specific color change, and as another example, the position and the display form of the virtual object change. It is, however, needless to say that it is possible to achieve a similar game even if the display form of the virtual object does not change. Alternatively, it is possible to achieve a game where only the display form of a virtual object overlapping a subject of a specific color changes. With reference to FIGS. 16A and 16B, a description is given below of a fourth game example where only the display form of a virtual object overlapping a subject of a specific color changes. It should be noted that FIG. 16A is a diagram showing an example where in the fourth game example, display is performed on the upper LCD 22 such that a virtual world image is combined with the camera image CI. FIG. 16B is a diagram showing an example where in the fourth game example, display is performed on the upper LCD 22 such that a blue subject included in the camera image CI and virtual objects are displayed so as to overlap each other.

Also in FIGS. 16A and 16B, in the fourth game example, on the upper LCD 22, a camera image CI is displayed, which is a real world image captured by a real camera built into the game apparatus 10 (e.g., the outer capturing section 23). For example, in the fourth game example, a real-time real world image (moving image) captured by the real camera built into the game apparatus 10 is displayed on the upper LCD 22.

In FIG. 16A, in the fourth game example, display is performed on the upper LCD 22 such that a virtual world image in which a plurality of fixed cubes CBf and a player character PC are placed is combined with the camera image CI. Here, all the plurality of fixed cubes CBf are placed at a reference height in the virtual world. The player character PC is capable of moving on the fixed cubes CBf, and moves to a goal in the virtual world in accordance with an operation of the player (e.g., an operation on the cross button 14A or the analog stick 15). On the other hand, in a gap formed between the plurality of fixed cubes CBf, flame objects F each representing a flame are placed. If the flame objects F are placed on a path to the goal, the player character PC is incapable of passing through the flame objects F. It should be noted that the example shown in FIG. 16A shows the case where in the camera image CI displayed on the upper LCD 22, a non-blue subject (e.g., a white subject) is captured, and the subject and all the flame objects F are displayed so as to overlap each other.

In FIG. 16B, in the camera image CI displayed on the upper LCD 22, a blue subject is captured, and the blue subject and the flame objects F are displayed so as to overlap each other. In this case, the flame objects F may overlap the blue subject, whereby rain objects W representing a rainfall state are placed on the flame objects F. In the course of time, the flame objects F are gradually reduced and disappear in such a manner that flames are extinguished by rain, and new cubes CBn appear. That is, the flame objects F may overlap a blue subject, whereby, after the rain objects W are added to the upper portions of the flame objects F, the flame objects F are gradually reduced, and change in display form to the new cubes CBn. Consequently, the flame objects F placed on the fixed cubes CBf change to the new cubes CBn. This enables the player character PC to move on the cubes CBn. That is, when it is necessary to cause the flame objects F to disappear in order to lead the player character PC to the goal, the player of the game apparatus 10 may capture a blue subject so as to overlap the flame objects F, and thereby can clear obstacles formed by the objects. It should be noted that the rain objects W having appeared on the fixed cube CBf on the basis of the fact that the flame objects F has overlapped the blue subject may be caused to disappear in conjunction with the disappearance of the flame objects F. Alternatively, the velocity of the flame objects F being gradually reduced, disappearing, and changing in display form to the new cubes CBn may vary depending on the saturation or the brightness of the subject displayed so as to overlap the flame objects F, or may be fixed to a velocity set in advance.

It should be noted that in the fourth game example described above, as an example, a virtual object is displayed so as to overlap a blue subject, and the virtual object changes in display form. The change in display form of the virtual object may require a plurality of stages. A possible example of this is as follows. A virtual object representing plants and flowers may overlap a blue subject, whereby the virtual object is given water. Then, the virtual object may further overlap a red subject, whereby the virtual object is exposed to sunlight. Thus, the virtual object may change in display form such that the plants and flowers grow through such a plurality of stages.

In addition, when a player character that moves in the virtual world in accordance with an operation of the player has overlapped a subject of a specific color, the parameters (e.g., movement parameters such as the moving velocity and the jump distance) of the player character may be varied. For example, when a player character that moves in the virtual world in accordance with an operation on the cross button 14A or the analog stick 15 is displayed so as to overlap a subject of a specific color, the player character is moved at a relatively high velocity or a relatively low velocity relative to an operation of the same movement. As described above, when a player character overlaps a subject of a specific color, the parameters of the player character may be varied, whereby it is possible to achieve a game having a new flavor.

In addition, in the game examples described above, at least one of the shape, the position, and the display form of a virtual object overlapping a subject of a specific color changes. Alternatively, when the virtual world image is combined with the camera image, a virtual object not overlapping the subject may also be changed. For example, if a specific-colored subject is captured in the camera image displayed on the upper LCD 22, at least one of the shape, the position, and the display form of, among virtual objects displayed on the upper LCD 22, the virtual object that changes on the basis of the specific color may be changed. In this case, when the virtual object is changed, the user of the game apparatus 10 does not need to display the virtual object and the specific-colored subject so as to overlap each other, but only needs to capture with the real camera the specific-colored subject so as to be included at least in the capturing range.

In addition, in the above descriptions, as an example, a camera image CI acquired from either one of the outer capturing section 23 and the inner capturing section 24 is displayed on the upper LCD 22 as a planar image (a planar view image, as opposed to the stereoscopically visible image described above) of the real world. Alternatively, a real world image stereoscopically visible with the naked eye (a stereoscopic image) may be displayed on the upper LCD 22. For example, as described above, the game apparatus 10 can display on the upper LCD 22 a stereoscopically visible image (stereoscopic image) using camera images acquired from the left outer capturing section 23a and the right outer capturing section 23b. In this case, drawing is performed such that in accordance with the positional relationship between a specific-colored subject included in the stereoscopic image displayed on the upper LCD 22 and a virtual object, at least one of the shape, the position, and the display form of the virtual object changes.

For example, to perform drawing such that the virtual object changes in accordance with the specific-colored subject included in the stereoscopic image, the display control processing described above is performed using a left-eye image obtained from the left outer capturing section 23a and a right-eye image obtained from the right outer capturing section 23b. Specifically, in the display control processing shown in FIG. 12, a perspective transformation may be performed from two virtual cameras (a stereo camera), on the cubes CB and the ball object BL that are placed in the virtual space, whereby a left-eye virtual world image and a right-eye virtual world image are obtained. Then, a left-eye display image is generated by combining a left-eye image (a camera image obtained from the left outer capturing section 23a) with the left-eye virtual world image, and a right-eye display image is generated by combining a right-eye image (a camera image obtained from the right outer capturing section 23b) with the right-eye virtual world image. Then, the left-eye display image and the right-eye display image are output to the upper LCD 22.

In addition, in the above descriptions, a real-time moving image captured by the real camera built into the game apparatus 10 is displayed on the upper LCD 22, and display is performed such that the moving image (camera image) captured by the real camera is combined with the virtual world image. In the present invention, however, the images to be displayed on the upper LCD 22 have various possible variations. As a first example, a moving image recorded in advance, or a moving image or the like obtained from television broadcast or another device, is displayed on the upper LCD 22. In this case, when the moving image is displayed on the upper LCD 22, and a specific-colored subject is included in the moving image, at least one of the shape, the position, and the display farm of a virtual object changes in accordance with the specific-colored subject. As a second example, a still image obtained from the real camera built into the game apparatus 10 or another real camera is displayed on the upper LCD 22. In this case, when the still image obtained from the real camera is displayed on the upper LCD 22, and a specific-colored subject is included in the still image, at least one of the shape, the position, and the display form of a virtual object changes in accordance with the specific-colored subject. Here, the still image obtained from the real camera may be a still image of the real world captured in real time by the real camera built into the game apparatus 10, or may be a still image of the real world captured in advance by the real camera or another real camera, or may be a still image obtained from television broadcast or another device.

In addition, in the above embodiment, the upper LCD 22 is a parallax barrier type liquid crystal display device, and therefore is capable of switching between stereoscopic display and planar display by controlling the on/off states of the parallax barrier. In another embodiment, for example, the upper LCD 22 may be a lenticular type liquid crystal display device, and therefore may be capable of displaying a stereoscopic image and a planar image. Also in the case of the lenticular type, an image is displayed stereoscopically by dividing two images captured by the outer capturing section 23, each into vertical strips, and alternately arranging the divided vertical strips. Also in the case of the lenticular type, an image can be displayed in a planar manner by causing the user's right and left eyes to view one image captured by the inner capturing section 24. That is, even the lenticular type liquid crystal display device is capable of causing the user's left and right eyes to view the same image by dividing one image into vertical strips, and alternately arranging the divided vertical strips. This makes it possible to display an image, captured by the inner capturing section 24, as a planar image.

In addition, in the above embodiment, as an example of a liquid crystal display section including two screens, the descriptions are given of the case where the lower LCD 12 and the upper LCD 22, physically separated from each other, are placed above and below each other (the case where the two screens correspond to upper and lower screens). The present invention, however, can be achieved also with an apparatus having a single display screen (e.g., only the upper LCD 22), or an apparatus that controls the display of an image to be displayed on a single display device. Alternatively, the structure of a display screen including two screens may be another structure. For example, the lower LCD 12 and the upper LCD 22 may be placed on the left and right of a main surface of the lower housing 11. Alternatively, a higher-than-wide LCD that is the same in width as and twice the height of the lower LCD 12 (i.e., physically one LCD having a display size of two screens in the vertical direction) may be provided on a main surface of the lower housing 11, and two images (e.g., a captured image and an image indicating an operation instruction screen) may be displayed on the upper and lower portions of the main surface (i.e., displayed adjacent to each other without a boundary portion between the upper and lower portions. Yet alternatively, an LCD that is the same in height as and twice the width of the lower LCD 12 may be provided on a main surface of the lower housing 11, and two images may be displayed on the left and right portions of the main surface (i.e., displayed adjacent to each other without a boundary portion between the left and right portions). In other words, two images may be displayed using two divided portions in what is physically a single screen. Further, when two images are displayed using two divided portions in what is physically a single screen, the touch panel 13 may be provided on the entire screen.

In addition, in the above descriptions, the touch panel 13 is integrated with the game apparatus 10. It is needless to say, however, that the present invention can also be achieved with the structure where a game apparatus and a touch panel are separated from each other. Further, the touch panel 13 may be provided on the surface of the upper LCD 22, and the display image displayed on the lower LCD 12 in the above descriptions may be displayed on the upper LCD 22. Furthermore, when the present invention is achieved, the touch panel 13 may not need to be provided.

In addition, in the above embodiment, the descriptions are given using the hand-held game apparatus 10. The present invention, however, may be achieved by causing an information processing apparatus, such as a stationary game apparatus and a general personal computer, to execute the display control program according to the present invention. In this case, using a capturing device whose capturing direction and capturing position can be changed by the user, a real world image obtained from the capturing device may be used, whereby it is possible to achieve similar display control processing. Alternatively, in another embodiment, not only a game apparatus but also a given hand-held electronic device may be used, such as a personal digital assistant (PDA), a mobile phone, a personal computer, or a camera. For example, a mobile phone may include a display section and a real camera on the main surface of a housing.

In addition, in the above descriptions, the display control processing is performed by the game apparatus 10. Alternatively, at least some of the process steps in the display control processing may be performed by another device. For example, when the game apparatus 10 is configured to communicate with another device (e.g., a server or another game apparatus), the process steps in the display control processing may be performed by the cooperation of the game apparatus 10 and said another device. As an example, a case is possible where: the game apparatus 10 performs a process of setting a camera image; and another device acquires data concerning the camera image from the game apparatus 10, and performs the processes of steps 53 through 56. Then, a display image obtained by combining the camera image with the virtual world is acquired from said another device, and is displayed on a display device of the game apparatus 10 (e.g., the upper LCD 22). As another example, a case is possible where: another device performs a process of setting a camera image; and the game apparatus 10 acquires data concerning the camera image, and performs the processes of steps 53 through 56. Thus, when at least some of the process steps in the display control processing is performed by another device, it is possible to perform processing similar to the display control processing described above. That is, the display control processing described above can be performed by a processor or by the cooperation of a plurality of processors, the processor and the plurality of processors included in an information processing system that includes at least one information processing apparatus. Further, in the above embodiment, the processing of the flow chart described above is performed in accordance with the execution of a predetermined program by the information processing section 31 of the game apparatus 10. Alternatively, some or all of the processing may be performed by a dedicated circuit provided in the game apparatus 10.

It should be noted that the shape of the game apparatus 10, and the shapes, the number, the placement, or the like of the various buttons of the operation button 14, the analog stick 15, and the touch panel 13 that are provided in the game apparatus 10 are merely illustrative, and the present invention can be achieved with other shapes, numbers, placements, and the like. Further, the processing orders, the setting values, the formulas, the criterion values, and the like that are used in the display control processing described above are also merely illustrative, and it is needless to say that the present invention can be achieved with other orders, values, and formulas.

It should be noted that the display control program (game program) described above may be supplied to the game apparatus 10 not only from an external storage medium, such as the external memory 45 or the data storage external memory 46, but also via a wireless or wired communication link. Further, the program may be stored in advance in a non-volatile storage device of the game apparatus 10. It should be noted that examples of an information storage medium having stored thereon the program may include a CD-ROM, a DVD, and another given optical disk storage medium similar to these, a flexible disk, a hard disk, a magnetic optical disk, and a magnetic tape, as well as a non-volatile memory. Furthermore, the information storage medium for storing the program may be a volatile memory that temporarily stores the program.

While the invention has been described in detail, the foregoing description is in all aspects illustrative and not restrictive. It is understood that numerous other modifications and variations can be devised without departing from the scope of the invention. It is understood that the scope of the invention should be interpreted only by the appended claims. Further, throughout the specification, it should be understood that terms in singular form include the concept of plurality unless otherwise specified. Thus, it should be understood that articles or adjectives indicating the singular form (e.g., “a”, “an”, “the”, and the like in English) include the concept of plurality unless otherwise specified. It is also understood that one skilled in the art can implement the invention in the equivalent range on the basis of the description of the invention and common technical knowledge, from the description of the specific embodiments of the invention. Furthermore, it should be understood that terms used in the present specification have meanings generally used in the art unless otherwise specified. Therefore, unless otherwise defined, all the jargons and technical terms have the same meanings as those generally understood by one skilled in the art of the invention. In the event of any contradiction, the present specification (including meanings defined herein) has priority.

A storage medium having stored thereon a display control program, a display control apparatus, a display control system, and a display control method, according to the present invention can set and perform display control on a new image using a real world image, and therefore are suitable for use as a display control program, a display control apparatus, a display control system, a display control method, and the like that perform, for example, a process of displaying various images on a display device.

What is claimed is:

1. A computer-readable storage medium having stored thereon a display control program to be executed by a computer of a display control apparatus that displays an image on a display device, the display control program causing the computer to function as:
captured image acquisition means for acquiring a captured image captured by a real camera;
color detection means for, in the captured image acquired by the captured image acquisition means, detecting at least one pixel having specific range color information in color information including at least one selected from the group including RGB values, a hue, a saturation, and a brightness;
object setting means for, when the color detection means has detected the pixel having the specific range color information, changing, on the basis of the color information of the pixel, at least one of a shape, a position, and a display form of an object to be placed in a virtual world; and
image display control means for displaying on the display device an image of the virtual world where at least the object set by the object setting means is placed.

2. The computer-readable storage medium having stored thereon the display control program according to claim 1, the display control program further causing the computer to function as:
image combination means for generating a combined image obtained by combining the captured image acquired by the captured image acquisition means with the image of the virtual world where the object is placed, wherein
the image display control means displays the combined image generated by the image combination means on the display device.

3. The computer-readable storage medium having stored thereon the display control program according to claim 2, wherein
when the image combination means combines the captured image with the image of the virtual world such that the object is combined with the captured image so as to overlap the pixel having the specific range color information, the object setting means changes at least one of the shape, the position, and the display form of the object on the basis of the color information of the pixel.

4. The computer-readable storage medium having stored thereon the display control program according to claim 3, wherein
when the image combination means combines the captured image with the image of the virtual world such that the object is combined with the captured image so as to overlap a pixel having items of the color information indicating the saturation and the brightness that are equal to or greater than predetermined thresholds, respectively, and also having an item of the color information indicating the hue indicative of a value within a predetermined range, the object setting means changes at least one of the shape, the position, and the display form of the object on the basis of the color information of the pixel.

5. The computer-readable storage medium having stored thereon the display control program according to claim 3, wherein
in accordance with the saturation or the brightness of the pixel, the object setting means sets: an amount of change in shape by which the shape of the object to be combined with the captured image so as to overlap the pixel is changed; an amount of change in position by which the position of the object is changed; and a velocity of change by which the display form of the object is changed.

6. The computer-readable storage medium having stored thereon the display control program according to claim 3, the display control program further causing the computer to function as:
operation target object setting means for further placing in the virtual world an operation target object capable of moving in the virtual world while making contact with at least part of the object set by the object setting means, the operation target object being different from the object, wherein
the object setting means changes the shape or the position of the object to be combined with the captured image so as to overlap the pixel, and
the image display control means displays on the display device an image of the virtual world where the operation target object set by the operation target object setting means is placed in addition to the object set by the object setting means.

7. The computer-readable storage medium having stored thereon the display control program according to claim 6, wherein
when the image combination means combines the captured image with the image of the virtual world, the object setting means sets the shape and the position of an object to be combined with the captured image so as not to overlap the pixel having the specific range color information, to a reference shape and a reference position, respectively, and deforms the shape of, or moves the position of, an object to be combined with the captured image so as to overlap the pixel having the specific range color information, from the reference shape or the reference position, respectively.

8. The computer-readable storage medium having stored thereon the display control program according to claim 6, wherein
the operation target object setting means moves the operation target object in the virtual world in accordance with the shape or the position of the object changed by the object setting means.

9. The computer-readable storage medium having stored thereon the display control program according to claim 7, wherein
the object setting means: defaults the shape of the object to be combined with the captured image so as to overlap the pixel having the specific range color information, such that the shape is enlarged or reduced in a vertical direction from the reference shape; or moves the position of the object such that the position rises or falls from the reference position, and
the operation target object setting means places the operation target object on one of upper surfaces of a plurality of objects set by the object setting means, and moves the operation target object in the virtual world on the basis of differences in height between the upper surfaces of the plurality of objects.

10. The computer-readable storage medium having stored thereon the display control program according to claim 3, wherein
the object setting means changes the shape of the object to be combined with the captured image so as to overlap the pixel, by causing the object to extend or contract on the basis of the color information of the pixel.

11. The computer-readable storage medium having stored thereon the display control program according to claim 3, the display control program further causing the computer to function as:
fixed object setting means for further setting a plurality of fixed objects in a fixed manner at predetermined reference positions in the virtual world, wherein
when the image combination means combines the captured image with the image of the virtual world, the object setting means places, at a position different in height from the reference positions, an object to be combined with the captured image so as not to overlap the pixel having the specific range color information, and places, at substantially the same height as the heights of the reference positions, an object to be combined with the captured image so as to overlap the pixel having the specific range color information, and
the image display control means displays on the display device an image of the virtual world where the plurality of fixed objects set by the fixed object setting means are placed in addition to the object set by the object setting means.

12. The computer-readable storage medium having stored thereon the display control program according to claim 3, the display control program further causing the computer to function as:
fixed object setting means for further setting a plurality of fixed objects in a fixed manner at predetermined reference positions in the virtual world, wherein
the object setting means moves an object to be combined with the captured image so as to overlap the pixel having the specific range color information, such that the object goes back and forth within a gap between the plurality of fixed objects and at substantially the same height as heights of the reference positions, and
the image display control means displays on the display device an image of the virtual world where the fixed objects set by the fixed object setting means are placed in addition to the object set by the object setting means.

13. The computer-readable storage medium having stored thereon the display control program according to claim 11, the display control program further causing the computer to function as:
operation target object setting means for further placing in the virtual world an operation target object capable of, in accordance with an operation of a user, moving on the object placed at substantially the same height as the heights of the reference positions and on the fixed objects, the operation target object being different from the object and the fixed objects, wherein
the image display control means displays on the display device an image of the virtual world where the operation target object set by the operation target object setting means is placed in addition to the object set by the object setting means and the fixed objects set by the fixed object setting means.

14. The computer-readable storage medium having stored thereon the display control program according to claim 1, wherein
the color detection means calculates the color information to be used in a current detection process, by interpolating the color information of a currently acquired captured image with the color information calculated in a previous process.

15. The computer-readable storage medium having stored thereon the display control program according to claim 1, wherein
the object setting means sets a color of the object, on the basis of which at least one of the shape, the position, and the display form of the object is to be changed, to a complementary color of a color of the pixel having the specific range color information.

16. The computer-readable storage medium having stored thereon the display control program according to claim 3, the display control program further causing the computer to function as:
object movement control means for, in accordance with an operation of a user, moving in the virtual world the object set by the object setting means, wherein
when the object controlled to move by the object movement control means is combined with the captured image so as to overlap the pixel, the object setting means increases or decreases, on the basis of the color information of the pixel, a velocity at which the object movement control means moves the object.

17. The computer-readable storage medium having stored thereon the display control program according to claim 1, wherein
the color detection means includes:
block division means for dividing the captured image into blocks each including a plurality of pixels; and
block RGB average value calculation means for calculating average values of RGB values of pixels included in each block, wherein
the color detection means detects at least one pixel having the specific range color information, on the basis of the average values of each block.

18. The computer-readable storage medium having stored thereon the display control program according to claim 2, wherein
the captured image acquisition means repeatedly acquires captured images of a real world captured in real time by a real camera available to the display control apparatus,
the color detection means repeatedly detects pixels having the specific range color information in the captured images, respectively, repeatedly acquired by the captured image acquisition means,
the object setting means repeatedly changes at least one of the shape, the position, and the display form of the object on the basis of the color information repeatedly detected by the color detection means,
the image combination means repeatedly generates combined images by combining each of the captured images repeatedly acquired by the captured image acquisition means, with the image of the virtual world where the object is placed, and
the image display control means repeatedly displays on the display device the combined images obtained by combining each of the captured images repeatedly acquired by the captured image acquisition means, with the image of the virtual world.

19. The computer-readable storage medium having stored thereon the display control program according to claim 3, wherein
when the image combination means combines the captured image with the image of the virtual world such that the object is combined with the captured image so as to overlap the pixel having the specific range color information, and subsequently further combined with the captured image so as to overlap a pixel having color information of a range different from the specific range, the object setting means changes at least one of the shape, the position, and the display form of the object.

20. A display control apparatus that displays an image on a display device, the display control apparatus comprising:
captured image acquisition means for acquiring a captured image captured by a real camera;
color detection means for, in the captured image acquired by the captured image acquisition means, detecting at least one pixel having specific range color information in color information including at least one selected from the group including RGB values, a hue, a saturation, and a brightness;
object setting means for, when the color detection means has detected the pixel having the specific range color information, changing, on the basis of the color information of the pixel, at least one of a shape, a position, and a display form of an object to be placed in a virtual world; and
image display control means for displaying on the display device an image of the virtual world where at least the object set by the object setting means is placed.

21. A display control system, including a plurality of apparatuses configured to communicate with each other, that displays an image on a display device, the display control system comprising:
captured image acquisition means for acquiring a captured image captured by a real camera;
color detection means for, in the captured image acquired by the captured image acquisition means, detecting at least one pixel having specific range color information in color information including at least one selected from the group including RGB values, a hue, a saturation, and a brightness;
object setting means for, when the color detection means has detected the pixel having the specific range color information, changing, on the basis of the color information of the pixel, at least one of a shape, a position, and a display form of an object to be placed in a virtual world; and
image display control means for displaying on the display device an image of the virtual world where at least the object set by the object setting means is placed.

22. A display control method performed by a processor or a cooperation of a plurality of processors included in a display control system including at least one information processing apparatus capable of performing display control processing for displaying an image on a display device, the display control method comprising:
a captured image acquisition step of acquiring a captured image captured by a real camera;
a color detection step of, in the captured image acquired in the captured image acquisition step, detecting at least one pixel having specific range color information in color information including at least one selected from the group including RGB values, a hue, a saturation, and a brightness;
an object setting step of, when the pixel having the specific range color information has been detected in the color detection step, changing, on the basis of the color information of the pixel, at least one of a shape, a position, and a display form of an object to be placed in a virtual world; and
an image display control step of displaying on the display device an image of the virtual world where at least the object set in the object setting step is placed.
